(19) United States
(12) Patent Application Publication
(10) Pub. No.: US 2026/0067340 A1
(43) Pub. Date: Mar. 5, 2026

(54) CROSS-EXPERIENCE IMMERSIVE COMMUNICATION IN A VIRTUAL ENVIRONMENT

(71) Applicant: Roblox Corporation, San Mateo, CA (US)

(72) Inventors: Lukasz ZATORSKI, Sunnyvale, CA (US); Dmytro LAPCHUK, Mountain View, CA (US); John BACON, San Mateo, CA (US); Bryan NEALER, Sodus, MI (US); Jan BABARIK, San Mateo, CA (US); Brian LIANG, San Mateo, CA (US); Alex KATZ, San Mateo, CA (US); Alberto COVARRUBIAS GOMEZ, San Mateo, CA (US)

(73) Assignee: Roblox Corporation, San Mateo, CA (US)

(21) Appl. No.: 19/318,783

(22) Filed: Sep. 4, 2025

Related U.S. Application Data
(60) Provisional application No. 63/691,296, filed on Sep. 5, 2024.

(51) Int. Cl. H04L 65/1069; H04L 65/75

(52) U.S. Cl. CPC H04L 65/1069; H04L 65/75

(57) ABSTRACT

Methods, computer-readable media, and systems provide cross-experience communication in a virtual environment, including receiving a request from a requesting user in a first virtual experience to form a communication session with a receiving user in a second virtual experience; verifying a permission for the requesting user; in response to successfully verifying the permission: reserving a platform instance to coordinate forming the communication session; notifying the receiving user about the communication session; receiving a notification from the receiving user accepting the communication session; notifying the requesting user that the communication session was accepted; starting a designated data model to host the communication session; and forming the communication session between the requesting user and the receiving user using the designated data model and the platform instance, the designated data model having access to a subset of information in a data model associated with the receiving user related to the communication session.

### CROSS-REFERENCE TO RELATED APPLICATIONS

This application claims priority under 35 U.S.C. § 119 (e) to U.S. Provisional Patent Application No. 63/691,296, entitled “CROSS-EXPERIENCE IMMERSIVE COMMUNICATION IN A VIRTUAL ENVIRONMENT,” filed on Sep. 5, 2024, the content of which is incorporated herein in its entirety.

### TECHNICAL FIELD

This disclosure relates generally to user communication in a virtual environment, and more particularly but not exclusively, relates to methods, systems, and computer-readable media that provide cross-experience immersive communication features enabling two or more users to engage in real-time communication sessions, such as text-based communication sessions or voice communication sessions, while interacting across shared virtual experiences in the virtual environment.

### BACKGROUND

In a virtual environment, groups of users may wish to group up, join virtual experiences together, and communicate through a text communication session or a voice communication session. However, there are some common challenges. It may be difficult to set up a communication session between two or more users. It may also be difficult to handle some of the issues that arise when setting up, maintaining, and closing such communication sessions.

For example, it may be difficult to transition between different types of communication sessions, avoid exceeding available computing resources, protect users from non-permissible content, handle foregrounded and backgrounded communication sessions, and manage persistent information. These challenges are a detriment to the benefits provided by enhanced features that support seamless group interactions and communication across various virtual experiences, including text and voice communication sessions.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform or control performance of the actions.

According to one aspect, a computer-implemented method to provide cross-experience communication in a virtual environment that hosts a plurality of virtual experiences is provided, the method comprising: receiving a request from a requesting user in a first virtual experience of the virtual environment to form a communication session with a receiving user in a second virtual experience of the virtual environment; verifying a permission for the requesting user to form the communication session; in response to successfully verifying the permission: reserving a platform instance in the virtual environment to coordinate forming the communication session; notifying the receiving user about the communication session; receiving a notification from the receiving user accepting the communication session; notifying the requesting user that the communication session was accepted; starting a designated data model associated with the requesting user to host the communication session; and forming the communication session between the requesting user and the receiving user using the designated data model and the platform instance, the designated data model having access to a subset of information in a data model associated with the receiving user, wherein the subset of information is related to the communication session.

Various implementations of the computer-implemented method are described herein.

In some implementations, the communication session includes a private text communication session, a private voice communication session, a private immersive communication session hosted in the virtual environment, or a combination thereof.

In some implementations, the method further comprises transitioning from the private text communication session or the private voice communication session to the private immersive communication session, wherein the private immersive communication session is hosted as an additional virtual experience in the virtual environment.

In some implementations, the method further comprises monitoring the communication session in real time or near real time to detect if non-permissible content is provided by a particular user in the communication session; in response to detecting non-permissible content, performing at least one of: providing a warning to the particular user; providing a warning to another user; or taking a curative action, wherein the curative action comprises at least one of blocking the particular user from providing further content in the communication session, modifying the non-permissible content before the non-permissible content is provided to other users in the communication session, removing the particular user from the communication session, or blocking access of the particular user to the virtual environment.

In some implementations, the communication session is a voice communication session that is presented to a given user as a foregrounded voice communication session or a backgrounded voice communication session.

In some implementations, the designated data model does not replicate information related to foregrounded operation when the communication session is the backgrounded voice communication session, and the designated data model is updated to include the information related to the foregrounded operation if the foregrounded voice communication session takes on operation.

In some implementations, the method further comprises providing a voice heads-up-display (HUD) to the given user for controlling the communication session when the communication session is the backgrounded voice communication session.

In some implementations, the method further comprises detecting that providing one or more communication sessions exceeds available computing resource capacity, and responding by dropping a communication session, adjusting a quality of a foregrounded communication session virtual experience such that the adjusting results in reduction in a usage of computing resources, adjusting a quality of a backgrounded communication session experience such that the adjusting results in reduction in the usage, or a combination thereof.

In some implementations, information stored in the designated data model is removed on-demand in response to a corresponding communication session being backgrounded.

In some implementations, audio for a communication session may be muted and unmuted independently from environment audio from the first virtual experience or the second virtual experience.

In some implementations, persistent information for the designated data model is loaded when the receiving user joins the communication session, and updated persistent information is written to the designated data model when the receiving user leaves the communication session.

In some implementations, the method further comprises receiving a request from the requesting user to receive a list of eligible receiving users, wherein the requesting user selects the receiving user from the list.

According to another aspect, a non-transitory computer-readable medium is provided. The non-transitory computer-readable medium has instructions stored thereon that, responsive to execution by a processing device, causes the processing device to perform or control performance of operations to provide cross-experience communication in a virtual environment that hosts a plurality of virtual experiences, the operations comprising: receiving a request from a requesting user in a first virtual experience of the virtual environment to form a communication session with a receiving user in a second virtual experience of the virtual environment; verifying a permission for the requesting user to form the communication session; in response to successfully verifying the permission: reserving a platform instance in the virtual environment to coordinate forming the communication session; notifying the receiving user about the communication session; receiving a notification from the receiving user accepting the communication session; notifying the requesting user that the communication session was accepted; starting a designated data model associated with the requesting user to host the communication session; and forming the communication session between the requesting user and the receiving user using the designated data model and the platform instance, the designated data model having access to a subset of information in a data model associated with the receiving user, wherein the subset of information is related to the communication session.

Various implementations of the non-transitory computer-readable medium are described herein.

In some implementations, the communication session includes a private text communication session, a private voice communication session, a private immersive communication session hosted in the virtual environment, or a combination thereof.

In some implementations, the operations further comprise detecting that providing one or more communication sessions exceeds available computing resource capacity, and responding by dropping a communication session, adjusting a quality of a foregrounded communication session experience such that the adjusting results in reduction in a usage of computing resources, adjusting a quality of a backgrounded communication session experience such that the adjusting results in reduction in the usage, or a combination thereof.

In some implementations, information stored in the designated data model is removed on-demand in response to a corresponding communication session being backgrounded.

According to another aspect, a system is provided, the system comprising: a memory with instructions stored thereon; and a processing device, coupled to the memory, the processing device configured to access the memory and execute the instructions, wherein the instructions cause the processing device to perform or control performance of operations to provide cross-experience communication in a virtual environment that hosts a plurality of virtual experiences, the operations comprising: receiving a request from a requesting user in a first virtual experience of the virtual environment to form a communication session with a receiving user in a second virtual experience of the virtual environment; verifying a permission for the requesting user to form the communication session; in response to successfully verifying the permission: reserving a platform instance in the virtual environment to coordinate forming the communication session; notifying the receiving user about the communication session; receiving a notification from the receiving user accepting the communication session; notifying the requesting user that the communication session was accepted; starting a designated data model associated with the requesting user to host the communication session; and forming the communication session between the requesting user and the receiving user using the designated data model and the platform instance, the designated data model having access to a subset of information in a data model associated with the receiving user, wherein the subset of information is related to the communication session.

Various implementations of the system are described herein.

In some implementations, the communication session includes a private text communication session, a private voice communication session, a private immersive communication session hosted in the virtual environment, or a combination thereof.

In some implementations, the operations further comprise detecting that providing one or more communication sessions exceeds available computing resource capacity, and responding by dropping a communication session, adjusting a quality of a foregrounded communication session experience such that the adjusting results in reduction in a usage of computing resources, adjusting a quality of a backgrounded communication session experience such that the adjusting results in reduction in the usage, or a combination thereof.

In some implementations, information stored in the designated data model is removed on-demand in response to a corresponding communication session being backgrounded.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that facilitates cross-experience party voice features, in accordance with some implementations.

FIG. 2 is a diagram of screenshots of mobile devices, with party voice being on and off, in accordance with some implementations.

FIG. 3 is a diagram of a screenshot of a mobile device that has detected non-permissible content and is taking reactive action, in accordance with some implementations.

FIG. 4 is a diagram of a screenshot of a mobile device illustrating avatars having a party voice capability, in accordance with some implementations.

FIG. 5 is a diagram of a user interface (UI) of settings for a voice communication session, in accordance with some implementations.

FIG. 6 is a diagram of a screen shot of an electronic marketplace for a virtual environment platform, in accordance with some implementations.

FIG. 7 is a diagram of a system architecture for facilitating a communication session in a virtual environment, in accordance with some implementations.

FIG. 8 is another diagram of a system architecture for facilitating a communication session in a virtual environment, in accordance with some implementations.

FIG. 9 is a flowchart of a method for forming a communication session in a virtual environment, in accordance with some implementations.

FIG. 10A is a flowchart of a method for managing and changing between communication sessions in a virtual environment, in accordance with some implementations.

FIG. 10B is a flowchart of a method for managing resource availability in a virtual environment, in accordance with some implementations.

FIG. 11 is a flowchart of a method for detecting and responding to non-permissible content, in accordance with some implementations.

FIG. 12 is a flowchart of a method for managing foregrounded and backgrounded communication sessions, in accordance with some implementations.

FIG. 13 a flowchart of a method for managing persistent information as users join and leave communication sessions, in accordance with some implementations.

FIG. 14 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

The present disclosure is directed towards, inter alia, providing cross-experience immersive communication features, also referred to as party voice features, to enable text and voice communication sessions (or other types of communication session) for members of a shared virtual experience in a virtual environment. For example, the cross-experience immersive communication features may be implemented as various party communication features, an example of which are party voice features. Party voice (and other reference to voice communication) is one example of such party communication features and is used at times herein for illustrative purposes/examples. The features described herein can be implemented in communication sessions that may not necessarily involve voice, such as text, video, graphics, etc. The party voice features may run a concurrent, synchronized data model to enable and support cross-experience voice communication sessions or text communication sessions. For example, party voice features may use a three-dimensional (3D) game engine for online games. The party voice features may also permit switching between private party voice channels and public in-experience voice channels.

The supported party voice features may also include group communication sessions (voice/text/immersive experiences), voice expansion (to support other languages/countries), voice performance improvements, voice/text non-permissible/safety/toxicity content checks (checks that identify content violating of policies and react appropriately), instant voice access interfaces, audio application programming interfaces (APIs) that control audio communication and interactions between audio devices, various features to apply filters/conditions to voice streams in the party voice communication sessions, and use of the party voice input from a user as a control mechanism. There may also be a text to voice feature to support users that lack a microphone.

### Problem

A problem addressed herein is that coordinating communication between users in a virtual environment may be difficult. At present, there are no easy or efficient ways to coordinate communication between groups of users in a virtual environment. Such groups may include two or more users in a virtual environment. It is difficult to coordinate interaction between groups of users, both with respect to forming the communication sessions and facilitating text and voice communication (for example) between users in the groups in a flexible, convenient manner. It may be difficult for users in such groups to set up communication sessions and exploit potential features in such communication sessions to enhance the communication session experience.

### Solution

To help ameliorate the difficulty of communication for groups of users, one or more examples of the technical solution operates in a context in which a platform to assemble communications sessions for groups of users is provided. The technical solution provides additional infrastructure that enables a party voice capability (or another capability, such as a text communication session) for the parties supported by the platform. The infrastructure provides an improved way to set up, maintain, and terminate communication sessions, as well as provide functionality to improve user experience and functionality in such communication sessions.

The capability may permit the users to have access to certain features that enhance the communication session. For example, the features may include seamlessly and easily switching between a public and private communication channel. The features may also include various features to control the communication channel such as instant voice access, an audio application programming interface (API), settings/effects features that apply settings/effects to voice streams, neighbor features that apply modifications to voice streams, and voice control features that use voice stream as a basis for user control in a virtual environment. There may also be aspects of voice communication that are affected by the virtual environment, such as a louder volume based on proximity, or hearing background noise from a participant's location.

Games and related gaming functionality are provided for illustration and examples, and the features/functionality described herein can be adapted for other types of virtual environments that do not necessarily involve games.

### Party Voice

Party voice may be a set of communications features in a virtual environment that implements virtual parties of two or more users and coordinates communication sessions between members of the party. For example, parties may be an extension to a platform communication session that permits a small group of friends and/or colleagues (e.g., 2-20 users with a reason to play in a virtual environment together) to group up, join experiences together, and communicate with text/voice/other across experiences. For example, such interaction may occur for users in more than one different virtual experience. Party voice may thus provide and manage a party voice communication channel for users in the party.

Party voice may be active and/or available only for users who are of a certain age. For example, party voice may be active and/or available only for users who are 13 years old or older. There may also be restrictions on location, such that party voice may be active and/or available only for users who live in a certain country or jurisdiction within a country.

A configurable age/location verification feature may be implemented to restrict access to the party voice features to users who meet a specified age criterion and/or location criterion, thereby mitigating potential risks associated with interactions between minors and adults. Additional safety features may be incorporated, such as reporting features and responsive features for inappropriate behavior or abuse or other non-permissible content, to protect users and maintain a safe environment.

There may be a variety of actions taken by users to manage parties and communication sessions. These actions may include invite/add, leave, friend/unfriend, block/unblock, report, remove, ban from group, and remove from party and so forth. In some parties, there may also be an owner/administrator role, where users with such a role (or certain permissions) are permitted to perform certain tasks. Certain data about a party may be exposed in a limited manner inside a party or to certain users in a party. Other data may be visible from outside the party. These actions permit users to administer to the successful functioning and management of a party.

To coordinate the operation of party voice/text/other and corresponding communication sessions, various user interface (UI) elements may be used. For example, there may be player tiles (with information about players in the group) and a communication control bar to control communication.

There may also be various UI alerts provided to the users to help the users understand interaction between party and party voice functionality. There may also be UIs that present icons associated with other users in the party that permit a user to initiate a new communication session as a communication session between that user and at least one other user in the party. Such a communication session may be a voice communication session, but the communication session may also be a text communication session or other form of communication that may not necessarily involve voice/audio.

In some implementations, party voice may permit users to switch between a private voice channel communication session provided to a party and a public voice channel communication session that corresponds to every user in a virtual experience. Thus, the user may turn party voice features on and off. Additionally, there may be more than one private voice channel communication session associated with differing groups of users. For example, if a requesting user initiates multiple party voice communication sessions, such as a first private voice channel that provides a private communication session with a first group of users, and a second private voice channel that provides a private communication session with a second group of users.

Further, the parties may help define and implement a group communication session. In an alternative communication session implementation, a remote player receives audio using an audio input device, replicates the audio using an audio emitter device, and the audio is received by an audio listener of a local player. The audio listener provides the audio to the audio output of the local player.

As an alternative implementation in which there are multiple parties that form teams (such as a blue team and a red team), when using a party voice feature, local players may receive audio output sent by members of the same team. For example, if a local player is on a blue team, the local player may receive audio output sent by blue team members and audio output sent by red team members may not be received or may be ignored. In some implementations, the audio may include an embedded signature to establish at team with which the audio is associated. Such team functionality may add additional flexibility to managing communication sessions for members of a party.

Party voice may also enable a shift between three-dimensional (3D) immersive voice in-experience communication sessions and a two-dimensional (2D) flat voice/text communication for users to interact with corresponding friends. Another possible aspect of the party voice may be an in-experience invitation or hailing signal. Such a feature may automatically detect that two friends are in the same experience together. The invitation or hailing signal may invite the friends to form a party together or may suggest and/or initiate a party voice communication session.

Party voice communication sessions may be facilitated by an abstraction of a group of users available to a developers as an application programming interface (API) that is persistent across multiple developer environments. Additionally, the notation of grouping up users into parties may facilitate cross-experience communication sessions, as described with respect to party voice herein.

There may also be a cross-platform aspect to parties and party voice and corresponding communication sessions. Users may be able to shift seamlessly between text/voice/other communication sessions and immersive co-experience interaction as a group. The party voice may manage communication sessions between users in more than one virtual experience. There may be at least two aspects of various implementations. In one aspect, parties and party voice are cross-experience and users can communicate even when not in the same experience. Another aspect is that there may be an option for users in a party to enter a single immersive experience to chat, such as a lobby or hangout.

When in virtual experiences, party members are to have access to both the voice channel communication session and associated platform chat channel communication session. There may be some approaches to provide this capability. One approach is to use a communication session manager/UI element that can be repositioned and expanded to interact with the active party. As another approach, an active party may exist in an in-game menu. These approaches help coordinate the use of multiple channels. Some implementations can leverage notifications. Such notifications can include in-game notifications that show up while a user is in an experience as well as platform-specific notifications such as a push notification on a corresponding platform.

### Cross-Experience Voice Coordination

The cross-experience voice feature may be implemented using capabilities to coordinate between foreground data models (DMs) and the voice background DM. A data model, in the virtual environment, may refer to a root instance of a virtual environment's hierarchical structure that represents the game itself. A DM contains the objects that make up a place in a virtual environment/place, including the 3D world elements (parts, terrain, lighting), and objects that control runtime behavior (scripts). The DM is also potentially accessible through a global variable in game scripts.

The cross-experience voice feature involves implementing an interface to permit other DMs to communicate with custom functionality in that specific voice background DM. The techniques presented herein are scalable and do not compromise the safety and security of the virtual experience runtime.

As infrastructure to implement the cross-experience voice feature, a voice DM may provide specific information and functionality to other DMs in a restricted space. Also, the voice DM may report changes that affect the voice DM to other DM observers in the virtual environment.

Virtual experience controllers own a DM and the DMs have a reference of an experience service. The cross-experience voice controller owns a DM that is running concurrently in the background but does not render anything visible in a virtual experience. The cross-experience voice DM also has information to share with other portions of the virtual environment architecture. Information such as the player array may be stored along with the virtual experience.

The information from the DMs may not be accessible to creators or public scripts, just as private internal core scripts for use in managing the virtual environment. A cross-experience voice controller may have access to components capable of providing custom functionality (for example, playback/recording focus functionality via an audio focus manager). The cross-experience voice controller is also capable of implementing custom methods to provide surface functionality to interested parties (if the cross-experience voice controller has permission to do so).

Functionality may be provided using a flexible API for each operation that passes a dictionary of parameters and returns a dictionary of values (e.g., the functionality uses the same footprint as a function that provides for a cross-experience communication session that passes such dictionaries back and forth).

The cross-experience voice controller receives a reference to register its list of cross-experience communication sessions. This receipt happens during initialization and may be immutable until the controller is destroyed. The experience coordinator destroys the references to cross-experience communication sessions from the controllers.

The cross-experience communication sessions also deep copy any value that is passed as input from the code that runs the virtual experience. Also, the cross-experience communication sessions do not expose references/pointers (that is, perform a shallow copy) to values but instead perform full copies (deep copy) of any output value. In this way, the DMs state does not compromise the execution (e.g., thread safety).

The experience protocol implements functionality to forward cross-experience communication sessions to the experience coordinator. The experience coordinator is an authority that adds and executes cross-experience communication sessions. The experience coordinator extends functionality from a trait such as cross-experience executor.

The experience coordinator keeps track of the registered operations using a corresponding unique string (which may be referred to as a communication session ID). The operations correspond to the same signature as a cross-experience communication session. In some implementations, the experience coordinator is the only authority that responds to experience protocol communication sessions.

As an extension for an observer pattern, other DMs declare a global scoped callback that is accessible through the DM lifetime. Controllers that support observer are responsible for how to use the provided arguments, including parameters, a success callback, and an error callback. Controllers that support an observer are responsible for using explicit and clear naming conventions, as well as proper documentation. The observer can be provided via parameters or a success callback (here, a parameters dictionary with lambda notation is a preferred approach). The provided observer can be stored inside the controller. It is a controller responsibility to dispose of the observer when the observer is no longer relevant.

### Voice Expansion

Party voice may also provide for voice expansion features. Here, voice expansion refers to implementing voice communication in new countries and new languages. For example, such implementing of new countries/languages may aid in content moderation for the new countries/languages.

### Voice Performance

Party voice may also improve voice performance by processing voice streams using various techniques. For example, some of the techniques associated with parties and party voice may lead to reductions in computing frame time.

### Voice Non-Permissible Content/Safety/Toxicity/Violation Detection

Party voice may also improve voice safety by identifying non-permissible content that violates standards of the virtual environment and managing user access accordingly. For example, there may be various ways of providing real-time (or near real-time) voice or text non-permissible content detection. While these techniques may include performing toxicity detection, the techniques may also aid in the detection of unsafe content, or in the detection of any other content that violates virtual environments standards, policies, and/or rules (for example, improperly licensed copyrighted content or other intellectual property). Thus, a model that oversees the party voice communications channel detects non-permissible content (for example, toxic content) and can respond appropriately. For example, the response may be an applicable curative action.

In some implementations, a nudge approach provides for real-time (or near real-time) voice toxicity detection and user notification and assignment of corresponding consequences. In such a nudge approach, a non-permissible content detector (for example, a voice toxicity classification machine learning (ML) model) is run on the audio stream published from each user microphone to detect multiple toxicity classes (e.g., profanity, racism, bullying, and others) in real-time (or near real-time). A nudge approach responds by taking action (warning or corrective action) applied to the source of the non-permissible content to get the source user (the user causing the problem) to stop.

In some implementations, a reverse nudge approach provides real-time (or near real-time) toxicity detection and agency for affected users. Here, a non-permissible content detector (for example, a voice toxicity classification machine learning (ML) model) is run on the audio stream published from each user microphone to detect multiple toxicity classes (e.g., profanity, racism, bullying, and others) in real-time (or near real-time).

A reverse nudge approach responds by taking action (warning or corrective action) applied to the destination of the non-permissible content (the users adversely affected by the content) to protect the receiving user from receiving content that may have a negative effect on the receiving user if received.

Such an approach may provide immediate feedback to the affected users about the behavior of the offending user, giving agency to the affected users to take action against the offending user, for example to mute the offending user or remove the offending user from a group of users.

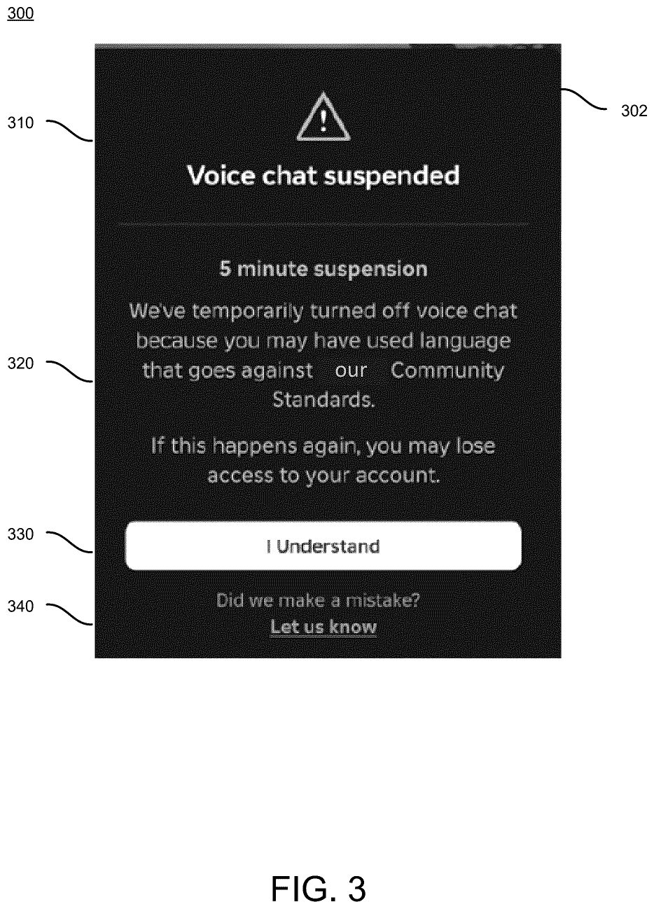

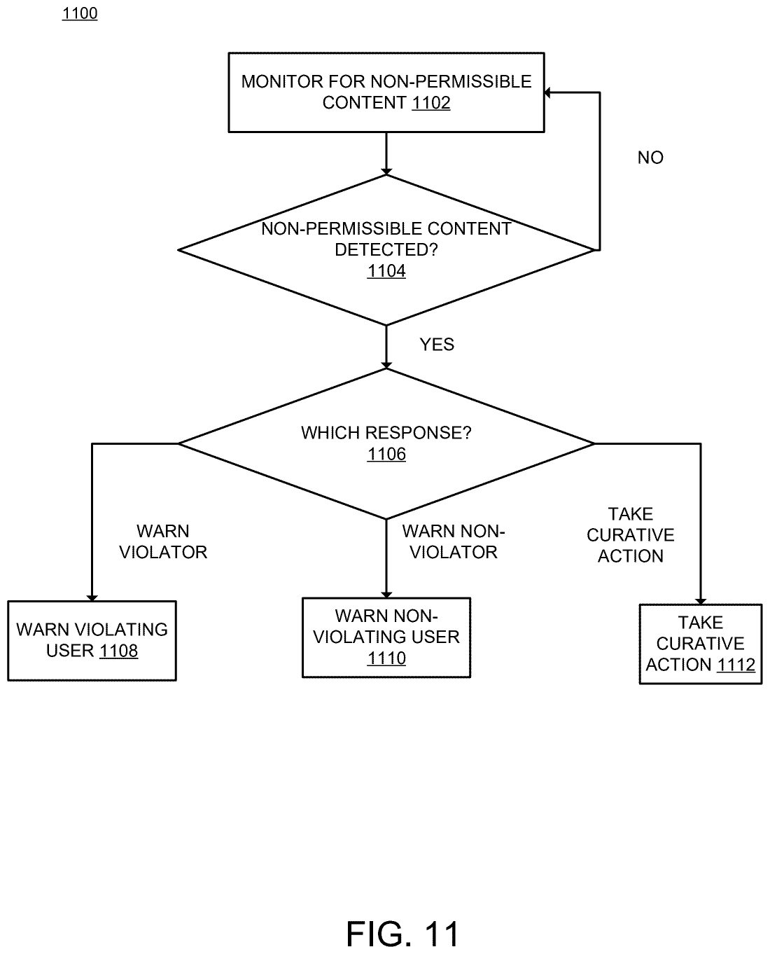

Additional aspects of this capability to manage non-permissible content of various implementations is discussed further with respect to FIG. 3 and FIG. 11.

### Instant Voice Access

Party voice may also provide UI controls to enable and interact with audio features. For example, a graphical toolbar or another UI element with controls to manage a party voice communication session may be overlaid at the top edge (or at another location) in a virtual environment, making it easy for users to establish party voice communication sessions with one another and control attributes of the voice communication sessions. These UI controls may provide the ability to manage the communication session itself as well as aspects of the content communicated via the communication session. There may also be some implementations that provide multiple ongoing private communication sessions.

### Audio API

Party voice may also provide features to manage the interaction between an audio player and other audio devices. For example, the audio player may use an audio API to control and interact with audio emitter(s) and/or audio analyzer(s). The API may control a variety of audio parameters on each end, as well as hardware settings from the audio hardware. For example, the audio may be modified to change aspects of its frequency, amplitude, timbre, sample rate, and bit depth, although these are only examples and many other characteristics are possible.

### Settings/Effects

A settings UI and an effects UI may provide features to manage the party voice communications. For example, a settings UI may provide various settings to manage party voice such as various sound effects to apply during party voice (e.g., volume, drinking, piano sound, voice communication effects, hear yourself, and muffle players in other rooms, etc.).

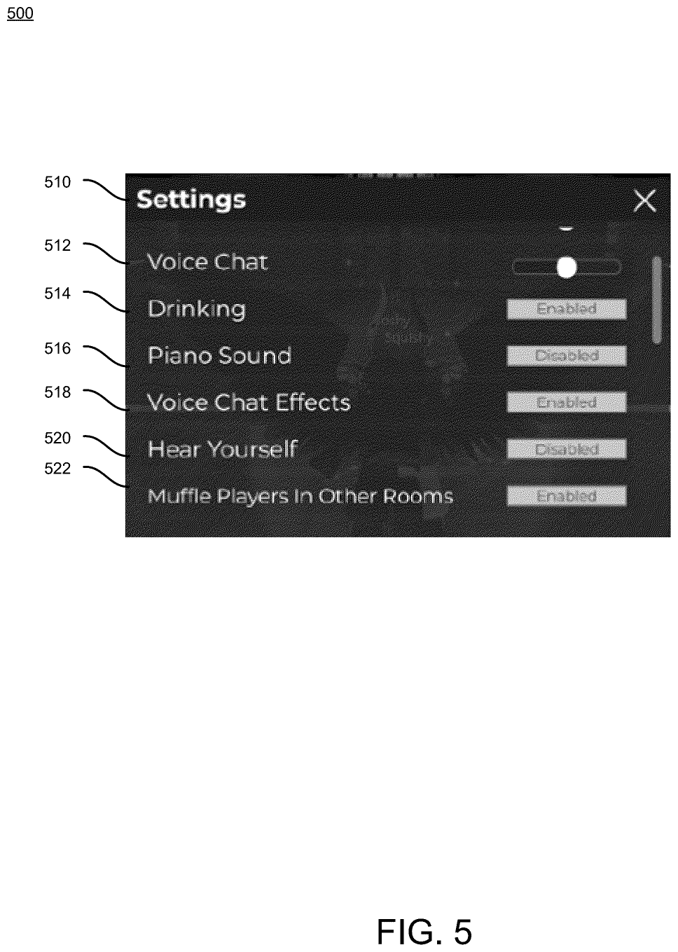

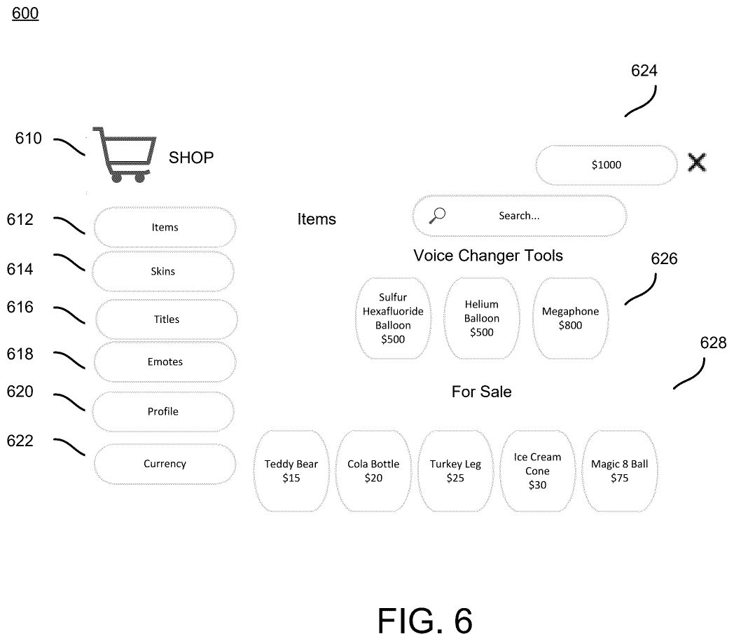

An effects UI may provide features to apply effects to voices (e.g., sulfur hexafluoride balloon, helium balloon, megaphone, etc.). Thus, the settings UI and/or the effects UI provide for settings/effects that are applied to voice communications. The selected vocal effect may allow the party voice to be more versatile by transforming the vocal content transmitted over the channel. Additional aspects of these features are illustrated at FIG. 5 and FIG. 6.

### Voice Control

As an aspect of party voice, party voice may incorporate the use of voice control. Here, the virtual environment may receive an audio input from a user and may use various techniques to process the audio input to determine a corresponding user action and implementing the corresponding user action. For example, there may be certain keywords that are known to correspond to user actions. Additionally, there may be a specific keyword or phrase instructing some implementations that the next phrase is an instruction rather than audio content to be transmitted.

### Example Communication Session

As an example implementation of forming a communication session (here, a voice communication session), there may be two users, Alice and Bob. Some implementations may vary somewhat from the example presented herein. Alice may be in a virtual environment, while Bob is playing a game in a virtual experience of the virtual environment. Alice requests a communication session in a platform communication manager for Alice and Bob through a new virtual experience. The platform communication manager verifies Alice's permissions, creates an entry for the new communication session, and notifies Bob about the communication session.

Bob accepts the communication session notification. The platform communication manager then notifies Alice and reserves a game server instance of the new virtual experience to host a communication session. Alice joins the new virtual experience at the game server via a game join mechanism (such as an API). The game join mechanism verifies Alice's permissions, finds the previously reserved instance, and tags that Alice is joining that instance in the foreground, corresponding to a game presence.

Then, Bob joins the game server via the game join mechanism. Alice's permissions to join a communication session with Bob may be verified again, the previously reserved instance found again, and tags that Bob based on that Alice is joining that instance in the foreground, corresponding to a communication session presence.

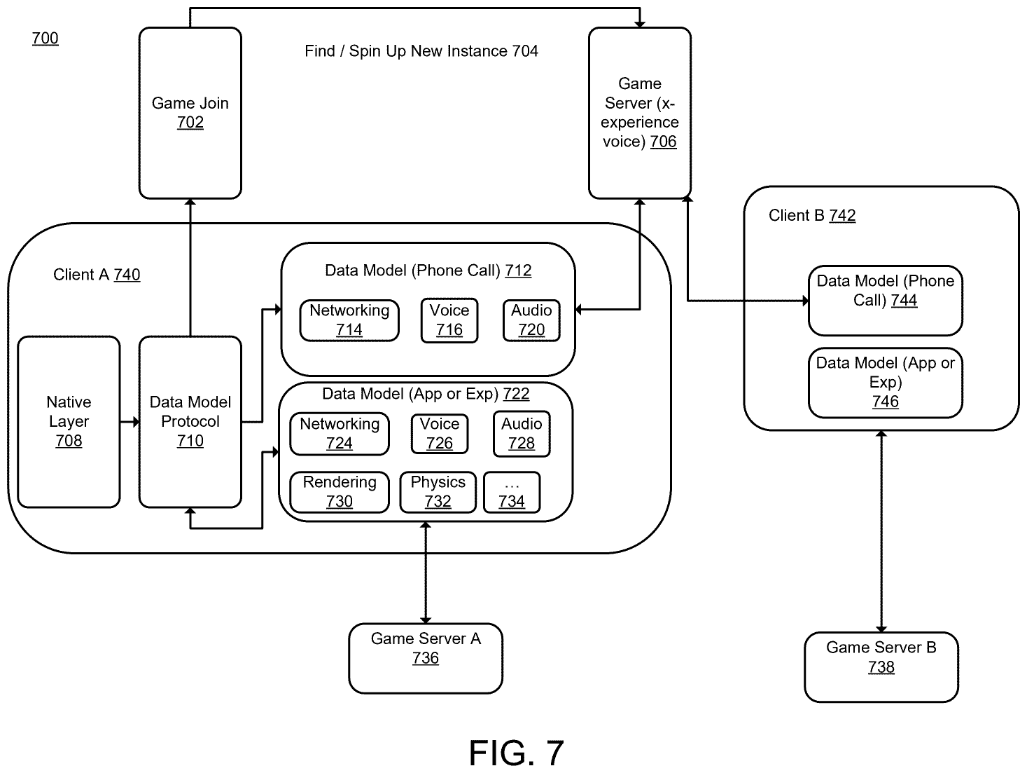

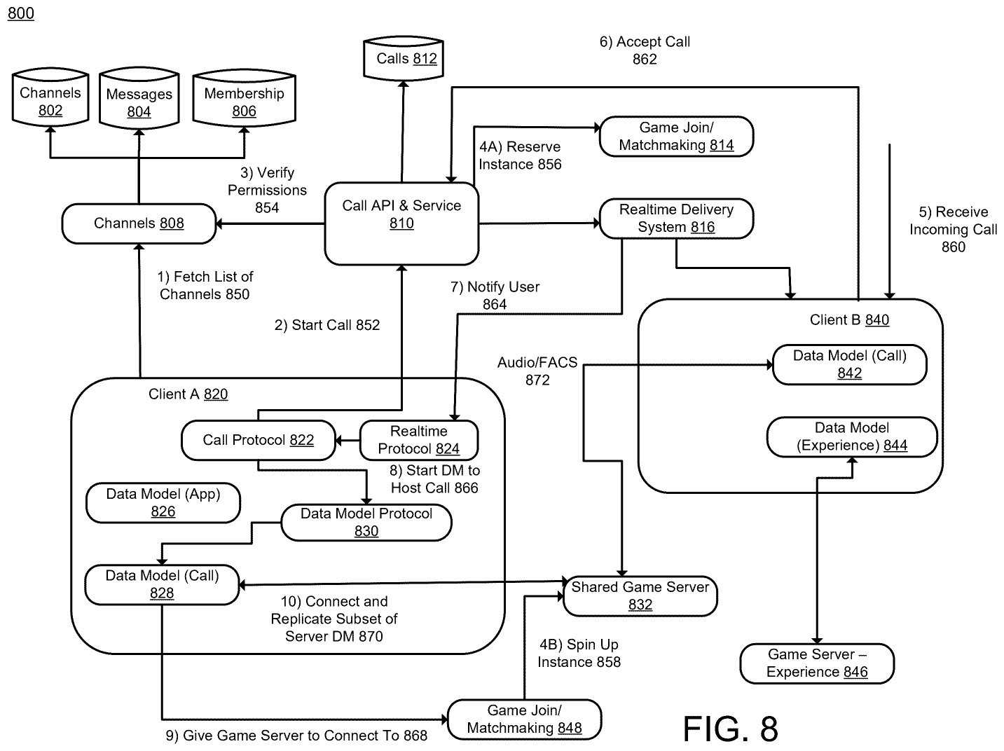

Alice and Bob are now in the same virtual experience server. The game server reports to the platform communication manager that both users have connected successfully. Alice connects as a player, while Bob connects to the virtual experience in the background (Bob is still in the first virtual experience, which is in the foreground). On connection of the communication session, microphone access is requested so that Alice and Bob can communicate by voice. This example relates to a particular voice communication session, and other sessions may vary accordingly. Additional details of such a process are discussed with respect to FIGS. 7-8.

Further details of various implementations are now described hereinafter.

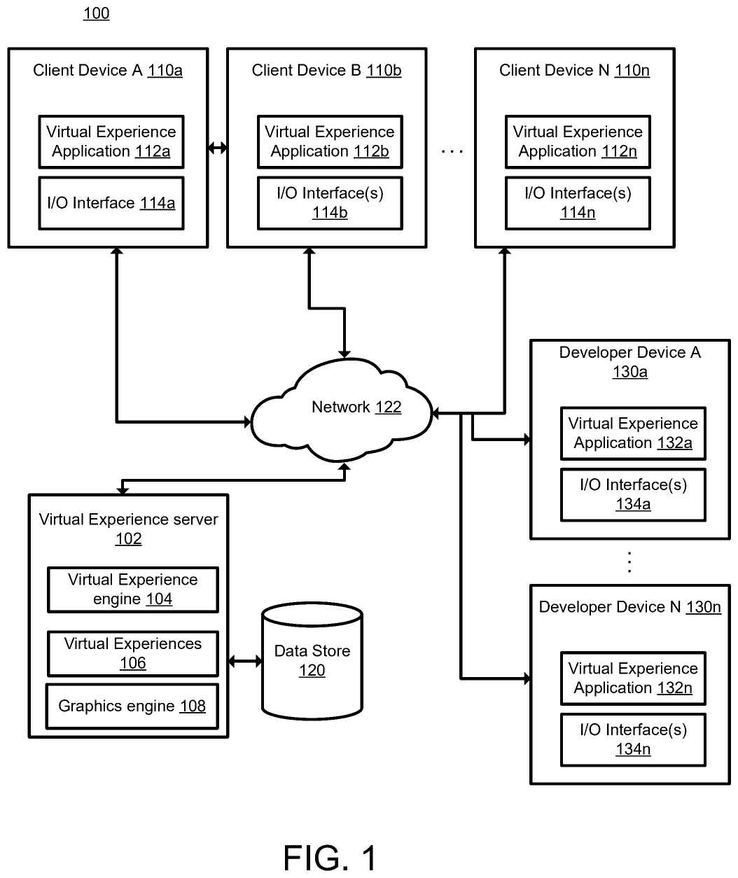

FIG. 1 is a diagram of an example system architecture that facilitates cross-experience party voice features, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

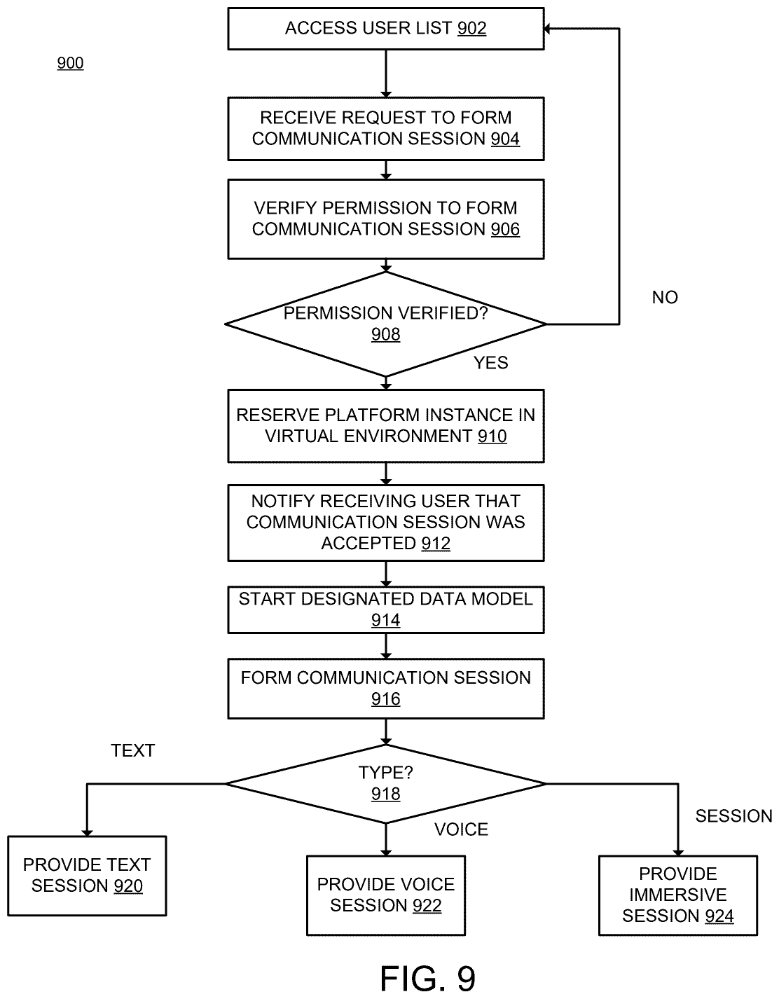

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 and/or some other component(s) in FIG. 1 may perform one or more of the operations described below in connection with the flowcharts shown in FIGS. 9, 10A-10B, and 11-13 and/or other operations described herein. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.).

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N: N synchronous and/or asynchronous text-based communication), or other form of communication. A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 110 may be used.

One or more characters (also referred to as an “avatar” or “model” herein) may be associated with a user where the user may control the character to facilitate a user's interaction with the virtual experiences 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application 112. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

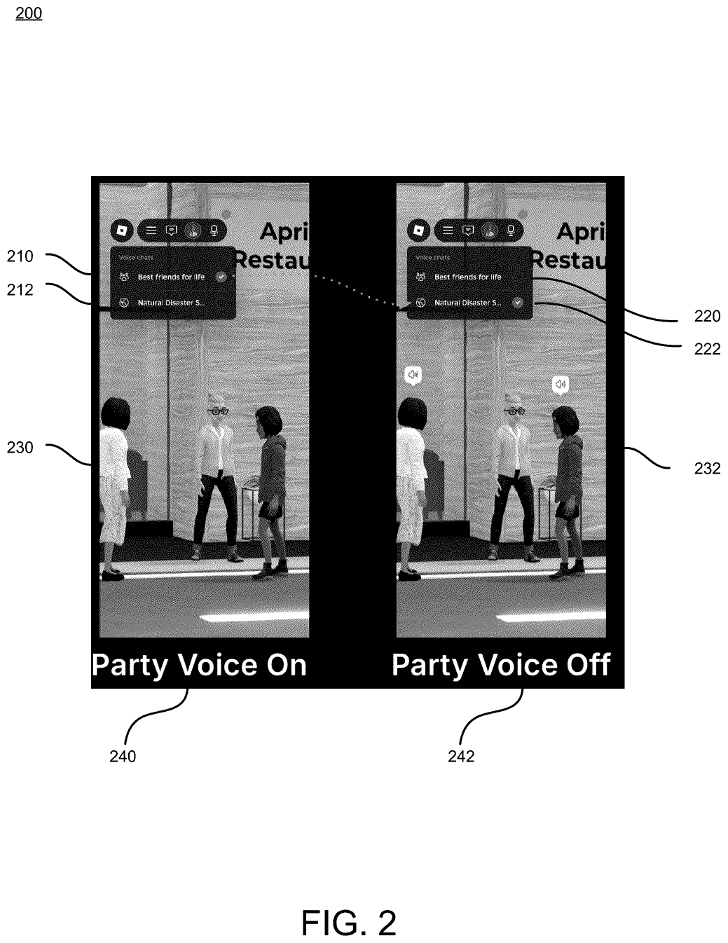

FIG. 2 is a diagram of screenshots of mobile devices, with party voice being on and off, in accordance with some implementations. The various screenshots shown and described herein may be provided by the I/O interface 114 of FIG. 1, for example. FIG. 2 illustrates a screenshot 240 of a mobile device with party voice on and a screenshot 242 of a mobile device with party voice off. While FIG. 2 refers to party voice in some implementations, in other implementation the party members may communicate using text, images, video, combined approaches, or an immersive experience in similar/analogous ways, as appropriate.

Screenshot 240 illustrates a selection menu with an option 210 for a communication session that includes the party voice approach and an option 212 for a communication session that does not include the party voice approach. Screenshot 240 also illustrates a group of avatars 230 that are members of a party voice group, but not necessarily in the same party. Because party voice is on, the users associated with the group of avatars 230 can communicate via a private voice channel that users associated with the group of avatars 230 in the virtual experience are able to hear.

FIG. 2 also illustrates a transition from the configuration illustrated in screenshot 240 to the configuration illustrated in screenshot 242. After the transition, option 220 for a party voice communication session is unselected and an option 222 for a communication session with party voice being off is selected. Accordingly, screenshot 242 illustrates a group of avatars 232 in alternative voice communication. Some of the avatars in the group of avatars 232 have sound icons above corresponding heads. These sound icons indicate that the audio from these avatars (for example, spoken utterances) are audible to all of the members of that experience and there is no private voice communication session.

While FIG. 2 presents an example of transitioning between a voice communication session with party voice on in screenshot 240 and a voice communication session with party voice off in screenshot 242, other forms of communication session may be transitioned between. For example, there may be a private text communication session that is visible and accessible to connected party members with party communication on and that is visual and accessible to all members of a virtual experience.

As another example, there may be a designated experience that is limited to use by members of a party to facilitate a communication session, which may toggle off the limitation to which users participate in the designated experience when party voice is off (that is, additional users may participate). In some implementations, there may be a combination of these modalities (for example, a private voice communication session and a private text communication session may be provided and may operate simultaneously). If there is a combination of modalities, the members of the party may be the same or the members may be wholly or partially different.

FIG. 3 is a diagram 300 of a screenshot 302 of a mobile device that has detected non-permissible content and is taking reactive action, in accordance with some implementations. The screenshot 302 illustrates a warning banner 310 that indicates that a voice communication session is suspended. The screenshot 302 also illustrates an explanation 320 of what a user may have done and what the responsive action is.

For example, the explanation 320 indicates that a violating user is subjected to a 5 minute suspension. This 5 minute suspension was imposed because “We've temporarily turned off voice chat because you may have used language that goes against our Community Standards. If this happens again, you may lose access to your account.” The screenshot 302 also provides a button 330 that permits the user to indicate that the user understands the penalty. While this characterizes the violating user as being a single user, in some implementations, the non-permissible content may originate from multiple users.

The screenshot 302 also provides a link 340 “Did we make a mistake? Let us know.” The link 340 acts as an appeal mechanism. If a user said something that resulted in a penalty (such as a suspended account or loss of access to an account), the link 340 addresses the situation that this determination may have been made in error. Such a link may allow the user to take various steps to appeal and remedy the restriction. For example, the appeal may take the user to a web page that permits the violating user to explain why the flagged issue was flagged improperly.

Alternatively or additionally, the appeal may open up an interaction with a human adjudicator (such as a voice communication session or a text communication session) so that a human administrator may discuss the user's actions and establish if the penalty was imposed by mistake. The appeal may also lead to changing the penalty. For example, if a penalty was imposed that permanently removes access to a user account, the penalty may be mitigated.

In this situation, a user in the voice communication session may have said something non-permissible. There are various types of utterances that may be considered non-permissible. These types may depend on policies associated with a given virtual experience or a given virtual environment. For example, such content may include toxic content (for example, hate speech, obscenities, bullying, etc.) or other forbidden content (such as copyrighted materials such as songs, videos, text, etc.), age inappropriate content (adult matter, rated matter based on user's ages), etc. Forbidden content is not limited to audio, and may also include forbidden pictures, or even interactions in a virtual experience that are inappropriate (for example, if a user directs an avatar to make an obscene gesture). Other implementations may consider other content non-permissible.

Such non-permissible content may be identified in a number of ways. For example, non-permissible content may be identified using a set of rules, reports received from users, a machine learning (ML) classifier (such as a neural network or another classifier), a large language model (LLM), etc. Forbidden content could also include inappropriate avatars and/or virtual items.

For example, a user may have taken one or more of the non-permissible actions. Once this is established, that user may be warned, other user(s) may be warned, or curative actions may be taken. These responses may be considered as being nudge actions (resolve the situation by interacting with the user who caused the problem) and reverse nudge actions (resolve the situation by interacting with the user(s) who did not cause the problem). Additional details of this aspect of implementations are discussed herein with respect to FIG. 11.

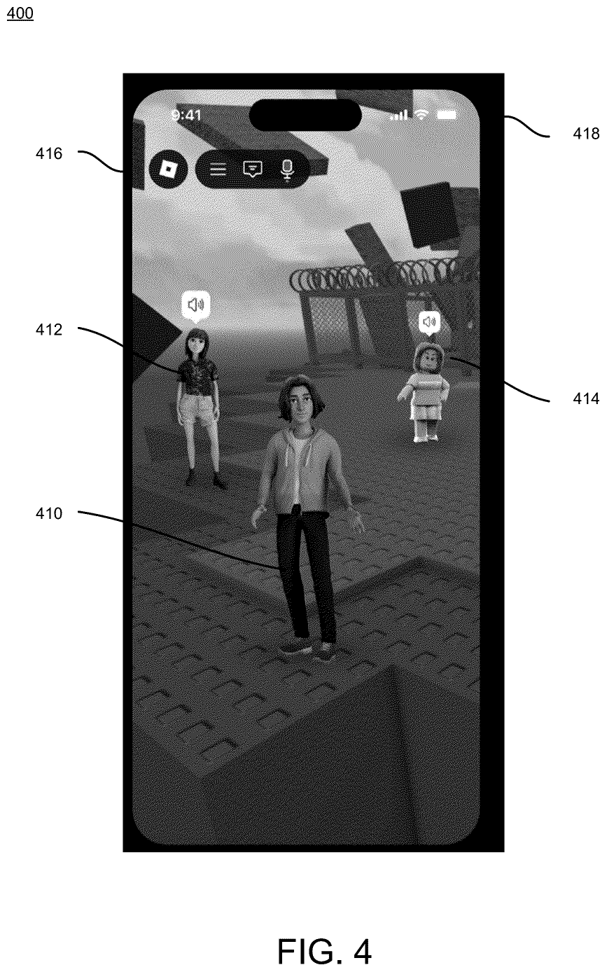

FIG. 4 is a diagram 400 of a screenshot of a mobile device illustrating avatars having a party voice capability, in accordance with some implementations. For example, FIG. 4 illustrates avatar 410, avatar 412, and avatar 414. Avatar 410 may have organized a party voice communication session with avatar 412 and avatar 414. Avatar 412 and avatar 414 are saying things in the context of a shared experience.

FIG. 4 also illustrates a control bar 416 and a status bar 418. For example, control bar 416 shows icons that manage a virtual experience, provide a menu of commands, initiate a text communication session, or initiate a voice communication session. Control bar 416 may include actions that open submenus that provide more commands. Control bar 416 is an example, and there may be other icons in addition to or instead of the icons presented in control bar 416.

Status bar 418 illustrates icons that provide information about the operating status of the mobile device. For example, the status bar 418 may illustrate information such as a time, a mobile network strength, a wireless network strength, and a battery status. Status bar 418 is an example, and there may be other icons in addition to or instead of the icons presented in status bar 418.

FIG. 5 is a diagram 500 of a user interface (UI) of settings for a voice communication session, in accordance with some implementations. In FIG. 5, a voice communication session is referred to as a voice chat. For example, FIG. 5 illustrates a window 510 of settings for a voice chat.

For example, window 510 may include a slider 512 to control a volume of a voice chat. The volume of the voice chat controlled by slider 512 may be controlled independently from a volume of a voice chat for one or more experiences in which participants residing in the voice chat interact. Additionally, another control (for example, a check box or a radio button, not shown) may mute the voice chat. Such muting may also occur independently from muting of one or more experiences in which participants residing the voice chat interact.

Window 510 also includes several other example settings for a voice chat that may be toggled on and off. For example, window 510 illustrates drinking 514, piano sound 516, voice chat effects 518, hear yourself 520, and muffle players in other rooms 522. For example, drinking 514 (illustrated as enabled) may control an effect that takes a user's speech and makes the user's speech sound like the user is drinking while speaking. Piano sound 516 (illustrated as disabled) may control an effect as to whether background piano music is audible or not.

Voice chat effects 518 (illustrated as enabled) may control whether various chat effects are audible. For example, such chat effects may be purchased in an electronic store, as discussed further with respect to FIG. 6. Hear yourself 520 (illustrated as disabled) may control whether a user's own audio is played back as part of a communication session. Muffle players in other rooms 522 (illustrated as enabled) may control whether sounds from other rooms may be muted and/or decreased in volume. While this setting is presented as a toggle in FIG. 5, there may be more specific settings (muffle individual users, to different extents) in some implementations.

While diagram 500 is directed to settings for a voice chat, it may be recognized that corresponding settings may be applied to a text chat or other form of communication. For example, the formatting of the text (font, size, formatting effects) may be varied using similar/analogous controls.

Additionally, if other modalities of communication are used, the user may be able to set settings for these modalities as well. For example, if users are placed in a designated experience to facilitate user communication, there may be settings that allow the users to manage joining/leaving the designated experience as well as what various users in the experience are permitted to do in the designated experience. Voice controls can be provided per active voice session. If a user is in a party and a public voice, the user may have separate controls for these communication sessions.

FIG. 6 is a diagram 600 of a screen shot of an electronic marketplace for a virtual environment platform, in accordance with some implementations. For example, the screen shot 610 illustrates an electronic shop. The electronic shop may sell various online products, such as items 612, skins 614, titles 616, emotes 618, profile 620, and currency 622.

There is a count 624 of how much electronic currency (for example, a currency associated with the virtual environment, a cryptocurrency, or a national currency) the user has. Count 624 shows a value of $1000. While count 624 illustrates a single number of currency units, the user may be associated with multiple forms of electronic currency or electronically transmitted currency. The electronic currency may be a currency associated with the virtual environment, one or more currencies associated with one or more of the virtual experiences, one or more cryptocurrencies, and/or one or more national currencies or other assets (precious metals, commodities, equities, debt assets, etc.). FIG. 6 also illustrates voice changer tools 626 and other items 628 for sale that are provided in screen shot 610.

Voice changer tools 626 include various items that, when used in a virtual experience, may affect what a user's voice sounds like, such as in a designated communication session. For example, FIG. 6 illustrates a sulfur hexafluoride balloon, a helium balloon, and a megaphone. These tools are associated with various prices. For example, each balloon has a price of $500, and the megaphone has a price of $800.

Sulfur hexafluoride inhaled in small quantities can lower the pitch of one's voice, making the speech sound deeper. This happens because sulfur hexafluoride is denser than air, causing sound waves to travel slower through sulfur hexafluoride than through air. This slower travel of sound waves through the denser gas results in a lower frequency of vibration in the vocal cords, leading to a deeper sound. Hence, simulating inhaling sulfur hexafluoride may modify sound in this way by making the sound deeper.

Inhaling helium can make a voice sound higher and squeakier because helium is lighter than air, causing sound waves to travel faster through helium. This property does not change the actual pitch generated by vocal cords, but helium does alter how the sound resonates in your vocal tract, amplifying higher frequencies. Hence, simulating inhaling helium may modify sound in this way by preferentially amplifying sounds having a higher frequency.

A megaphone can increase a volume associated with an utterance. Hence, simulating a megaphone may modify sound in this way, increasing the volume of sound provided to the input of the simulated megaphone.

While these items are associated with voice changing, it may be recognized that it is possible to sell items associated with text changing, such as selling fonts from an electronic store. There may also be other items 628 for sale, such as items for use in virtual experiences by avatars. Such other items 628 could include inventory objects, such as a teddy bear ($15), a cola bottle ($20), a turkey leg ($25), an ice cream cone ($30), or a magic 8 ball ($75). While such objects generally do not affect communication, if an avatar simulates eating or drinking, the corresponding sounds may change.

FIG. 7 is a diagram 700 of a system architecture for facilitating a communication session in a virtual environment, in accordance with some implementations. In FIG. 7, client A 740 is instructed by a user to set up a voice communication session with client B 742 (e.g., any of such clients discussed herein may be hosted on or embodied by the client devices 110 of FIG. 1). To do so, client A 740 connects to a game join function call 702, where the game join function call 702 performs operation 704 to find/spin up a new instance for a communication session. In FIG. 7, certain elements are referred to as “call” elements for convenience of reference, but it may be recognized that such elements pertain to various sorts of communication sessions and are not limited to calls (such as telephone or other voice calls).

In computing, “spinning up a communication session” means establishing a temporary, interactive exchange of information between two or more devices or between a computer and a user. Such spinning up is like initiating a phone communication session or starting a conversation online, where a dedicated connection or dialogue is created for the purpose of exchanging data or interacting. Such a session may be torn down or terminated at a later point (for example, when there are less than two people in the session).

Operation 704 leads to the establishment of a game server 706 for cross-experience voice communication sessions (though operation 704 may also facilitate other cross-experience communication sessions). The game server could be implemented as a physical device such as virtual experience server 102 or a virtual device or another software-define instantiation that resides in the virtual experience server 102. The game server 706 may also be referred to as “x-experience voice.”

Client A 740 may include a native layer 708, a data model protocol 710, and a data model 712 for a phone communication session and a data model 722 for an application (“app”) or experience.

The data model 712 for a phone communication session includes internal modules (which can be embodied in code or other executable computer-readable instructions), including a networking module 714, a voice module 716, and an audio module 720. The data model 722 for an app or experience includes internal modules, including a networking module 724, a voice module 726, an audio module 728, a rendering module 730, a physics module 732, as well as other modules 734 represented by “ . . . ” Such modules handle corresponding aspects of the relevant data models.

The data model 712 for the phone communication session connects to the game server 706 to handle the cross-experience voice. Game server 706 also is connected to client B 742, specifically to data model 744 for the voice communication session. The data model protocol 710 of client A may receive information from native layer 708 and interact with data model 712 for a phone communication session and further interact with a data model 722 for an app or experience. The data model 712 for a phone communication session is connected to the game server 706. The data model 722 for the app or experience is connected to game server A 736 to host the app or experience for client A 740.

Client B 742 also has a data model 744 for a phone communication session and a data model 746 for an app or experience. The data model 744 for the phone communication session helps client B 742 interact in a cross-experience communication session, hosted by game server 706 in conjunction with data model 712. Client B 742 also has another data model 746 to manage an app or experience in communication with game server B 738. Thus, client A 740 and client B 742 may be able to have a game server 706 providing cross-experience voice, but the app or experience they manage are kept separate and run on different game servers, game server A 736 and game server B 738.

The implementations presented in FIG. 7 present various techniques for managing communication sessions, which are managed somewhat differently by implementations as described in FIG. 8. In some implementations, creators may persist information about users (e.g., in datastores). The scripts that manipulate datastores run inside game server contexts and make an assumption that a user is only ever in one place (virtual experience) at a time. If a user can join any experience twice, providing this capability may break the persistence strategy or user interface.

For example, suppose that a virtual experience has an in-game currency, and the virtual experience loads-from-persistence on join, and saves-to-persistence on disconnect. The user joins the virtual experience, and the user may load the fact that the user has 100 units of electronic currency. The user joins the virtual experience a second time, and the second game server also loads 100 units of electronic currency. The first session spends some currency, then closes, and writes 50 currency to the database. Then the second session closes, and writes 100 currency to the db.

FIG. 8 is another diagram 800 of a system architecture for facilitating a communication session in a virtual environment, in accordance with some implementations. FIG. 8 illustrates client A 820 and client B 840 who wish to communicate with one another. Client A 820 includes a communication session protocol module 822, a real time protocol module 824, a data model 826 for an app, and a data model 828 for a communication session, and a data model protocol module 830. In FIG. 8, certain elements are referred to as “call” elements for convenience of reference, but it may be recognized that such elements can pertain to various sorts of communication sessions and are not limited to calls (such as telephone or other voice calls).

Client B 840 includes a data model 842 for a communication session, and a data model 844 for an experience. As illustrated in FIG. 8, there may be separate data models at client A 820 and client B 840 for the call and an application and/or experience.

FIG. 8 illustrates a number of other modules that participate in the formation and maintenance of a communication session between client A 820 and client B 840. For example, channels module 808 accesses information from channels datastore 802, messages datastore 804, and membership datastore 806. FIG. 8 also illustrates a call API and service module 810, which interacts with a calls datastore 812. There is also a game join/matchmaking module 814 and a real time delivery system module 816. Additionally, there is another game join/matchmaking module 848, and a shared game server 832 and a game server for the experience 846.

FIG. 8 presents a succession of operations to set up and form the communication session. In an operation 850, the client A 820 may fetch a list of channels from a channels module 808, which accesses channels datastore 802, messages datastore 804, and membership datastore 806 as the basis of this information. Operation 850 may be followed by operation 852.

In operation 852, client A 820 initiates the communication session (which may be a voice, text, or immersive communication session). Operation 852 may be implemented by having client A 820 use call protocol module 822 to initiate the call by opening the call with the assistance of call API and service module 810. Operation 852 may be followed by operation 854.

In operation 854, the call API and service module 810 may interact with the channels module 808 to verify that client A 820 has permissions to interact with client B 840. In some implementations, there may be no restrictions placed on which clients are able to interact with one another, and it is assumed that the operation 854 to verify permissions results in granted permissions.

In such implementations, operation 854 may be omitted. It may be helpful to verify permissions in that using such permissions may increase the safety and security of users. For example, users in certain age cohorts or nationalities may have certain restrictions on who is allowed to reach out to such users. For example, an adult user in the U.S. may be freely contacted by any user, while a thirteen year-old-in Ireland may have certain restrictions on who can contact that user or who users are allowed to contact. Operation 854 may be followed by operation 856.

In operation 856, an instance is reserved for the communication session. For example, the reserved instance may be a particular instance of a given virtual experience associated with one or more specified servers. By reserving a particular instance of the given virtual experience, it is possible to earmark an instance of the given virtual experience in which any users may be consolidated. If the users are in the same instance of the virtual experience, having the users in the same instance makes it easier for the users to communicate. Users can be in different virtual experience instances. However, if users wish to use party voice, the instance that is reserved is the one all party members connect to in order to communicate. Operation 856 may involve Game Join/Matchmaking module 814, such that clients connect, and the server spins up the server and reserves spots for the users to connect. The client does need to spin up its own data model, but not a server, as the server is spun up by an API/service. Operation 856 may be followed by operation 858.

In operation 858, an instance corresponding to the instance reserved in operation 856 may be spun up. For example, Game Join/Matchmaking module 848 may initiate a shared game server 832 hosting a particular virtual experience. Operation 858 may be followed by operation 860.

In operation 860, client B 840 receives an incoming call. For example, client B 840 receives a notification that client A 820 proposes forming a communication session with client B 840. Operation 860 may be followed by operation 862.

In operation 862, client B 840 accepts and responds to the incoming call requesting the communication session. Operation 862 may be followed by operation 864.

In operation 864, the initiating user (here, client A 820) is notified that the receiving user (here, client B 840) has accepted (in operation 862) the incoming call. For example, the real time delivery system module 816 may provide a signal to the real time protocol module 824 of client A 820 initiating the setup of the DM to host the call. Operation 864 may be followed by operation 866.

In operation 866, a data model 828 to host the call is started. For example, the call protocol module 822 starts an appropriate data model 828. Operation 866 may be followed by operation 868.

In operation 868, the data model 828 to host the call is provided. Operation 868 connects the data model 828 to host the call using a game join/matchmaking module 848, connecting data model 828 to a shared game server 832. Likewise, data model 842 to host the call at client B 840 participates in the call using the shared game server 832. Operation 868 may be followed by operation 870.

In operation 870, the shared game server 832 connects to the data model 828. As part of such a connection, a subset of the server data model related to the call is replicated. The shared game server 832 is also connected to data model 842 for the call and game server for the experience 846, where the game server for the experience 846 connects client B 840 to the communications session through the shared game server 832. These game servers are separate, such that the game server for the experience 846 is for a game for client B 840 and shared game server 832 manages private voice. As part of the voice communications session, an audio/facial action coding system (FACS) channel 872 is established.

FIG. 8 thus shows that client A 820 includes a data model 826 for an app and a separate data model 828 for the call, and client B 840 includes a data model 842 for the call and a data model 844 for the experience, and these data models are connected in specific ways that improve the interactions between client A 820 and client B 840.

While FIG. 8 illustrates various operations that may lead to the establishment of a communication session (which may be a private communication session) between users such as client A 820 and client B 840, the operations illustrated in FIG. 8 are just examples and are not to be taken as limiting. Other operations may be added, and certain operations may be reordered and/or omitted.

FIG. 9 is a flowchart of a method 900 for forming a communication session in a virtual environment, in accordance with some implementations. Method 900 may begin at block 902. For example, method 900 and other methods described herein may be performed by virtual experience server 102 and client device 110, as a non-limiting example.

At block 902, a user list is accessed. For example, the user list may be a list of eligible receiving users, and the user list may be requested by a requesting user. For example, if Alice wishes to initiate a communication session, Alice may be able to contact Bob and Charles, but not David. The members on the list may be accessed in a variety of ways. For example, a requesting user may be associated with a pregenerated list of users with whom the requesting user can communicate.

Alternatively or additionally, a requesting user may have a set of privileges, and these privileges may be usable to query a data storage with information about users. Based on the requesting user's privileges or other related settings, the query may provide a list of contact information for receiving users and the requesting user is allowed to contact. Block 902 is optional, and the requesting user may be identified in other ways. Block 902 may be followed by block 904.

At block 904, a request to form a communication session is received. For example, the requesting user may request a communication session with a selected receiving user. The receiving user may be a selected user from the user list obtained in block 902. In such an implementation, the request may imply that the requesting user has privileges to form a communication session with the receiving user. Alternatively or additionally, a requesting user may identify an arbitrary receiving user. The receiving user may participate in a same virtual experience as the requesting user. If this is not the case (e.g., the users are in different virtual experiences), various implementations can still set up a communication session using slightly modified techniques. Block 904 may be followed by block 906.

At block 906, permission to form the communication session is verified. As noted, if the receiving user is selected from a list of pre-authorized receiving users, the verification may be skipped or may be automatically approved. Otherwise, it is established whether the receiving user is an authorized user.

As discussed with respect to block 906, a receiving user may be approved for a given requesting user from a list or may be approved based on access privileges associated with a requesting user and/or a receiving user. Such approval may be approved unless there is a reason not to approve. For example, some implementations may approve a receiving user as long as the receiving user is not under 13 years of age. In some implementations, the approval may not be approved unless the receiving user meets a condition (e.g., residents of Indiana are able to be approached for a communication session but not residents of other locations). Block 906 may be followed by block 908.

At block 908, it is determined whether the permission was successfully verified at block 906. If the permission was verified, block 908 is followed by block 910 (the method 900 continues). If the permission was not verified, block 908 is followed by block 902 (the method 900 cannot continue and returns to the beginning). It may not be relevant to access the list of users again in a subsequent execution of block 902, and if the permission is not verified, block 908 may be followed directly by block 904.

At block 910, a platform instance is reserved in the virtual environment. Such a platform instance may be a particular instance of a virtual experience that is to be shared between users that participate in the communication session to facilitate the communication session. Block 910 may be followed by block 912.

At block 912, a receiving user is notified that the communication session is being requested. This notification may include an actual notification to the receiving user that a communication session is being requested (which the receiving user accepts) or the request may be automatically accepted. If the receiving user does not accept, the method 900 may terminate, and the communication session may be re-formed by starting again at block 902 or block 904. Block 912 may be followed by block 914.

At block 914, a designated data model is started. Such a data model provides the infrastructure to support and coordinate the communication session that is about to be formed. Block 914 may be followed by block 916.

At block 916, a communication session is formed. More specifically, the communication session may be formed between the requesting user and the receiving user using the designated data model and the platform instance. The designated data model may have access to a subset of information in a data model associated with the receiving user. The subset of information is related to the communication session. For example, a user A may be calling a user B and a communication session is formed. User A joins the session and is waiting for user B to arrive. User A might get access to information like whether user B is in the process of joining, whether user B is active, or whether user B declined to join. Block 916 may be followed by block 918.

At block 918, a type of communication session is determined. For example, the communication session may be a text communication session, a voice communication session, or an immersive session or other type of communication session. If the communication session is a text communication session, block 918 is followed by block 920. If the communication session is a voice communication session, block 918 is followed by block 922. If the communication session is an immersive session, block 918 is followed by block 924. The communication session may also combine these modalities or involve other modalities.

At block 920, a text communication session may be provided. The text communication session persists until the text communication session is shut down, either automatically or manually, or in response to a termination condition.

At block 922, a voice communication session may be provided. The voice communication session persists until the voice communication session is shut down, either automatically or manually, or in response to a termination condition.

As examples of a termination condition, various situations where it is helpful to shut down the session without a user request may occur. If user A wants to form a communication session with user B, user B might never accept the request to join. User B might join but then lose a connection and the servers might not have seen user B for a set amount of time. User A might block user B, or vice versa. The virtual environment might ban user B from using the virtual environment for some other reason unrelated to voice communication so that user B is no longer allowed in the virtual environment and is forced to disconnect from the session.

At block 924, an immersive communication session may be provided. The immersive communication session persists until the immersive communication session is shut down, either automatically or manually, or in response to a termination condition. The immersive communication session may take place is a separate virtual experience setting (for example, a beach, island, meeting room, etc.) that is separate from other virtual experiences that the requesting and receiving user participate in.

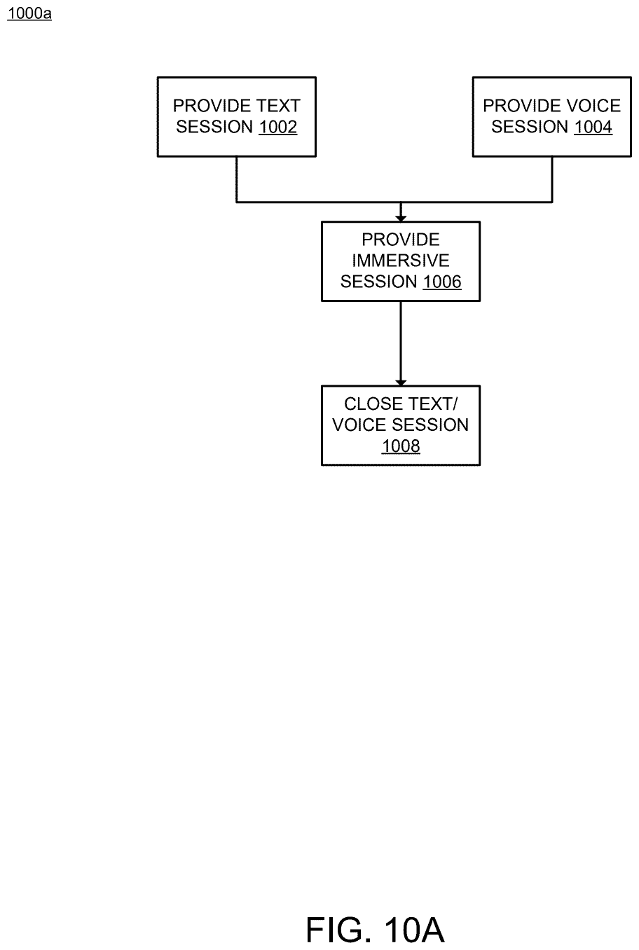

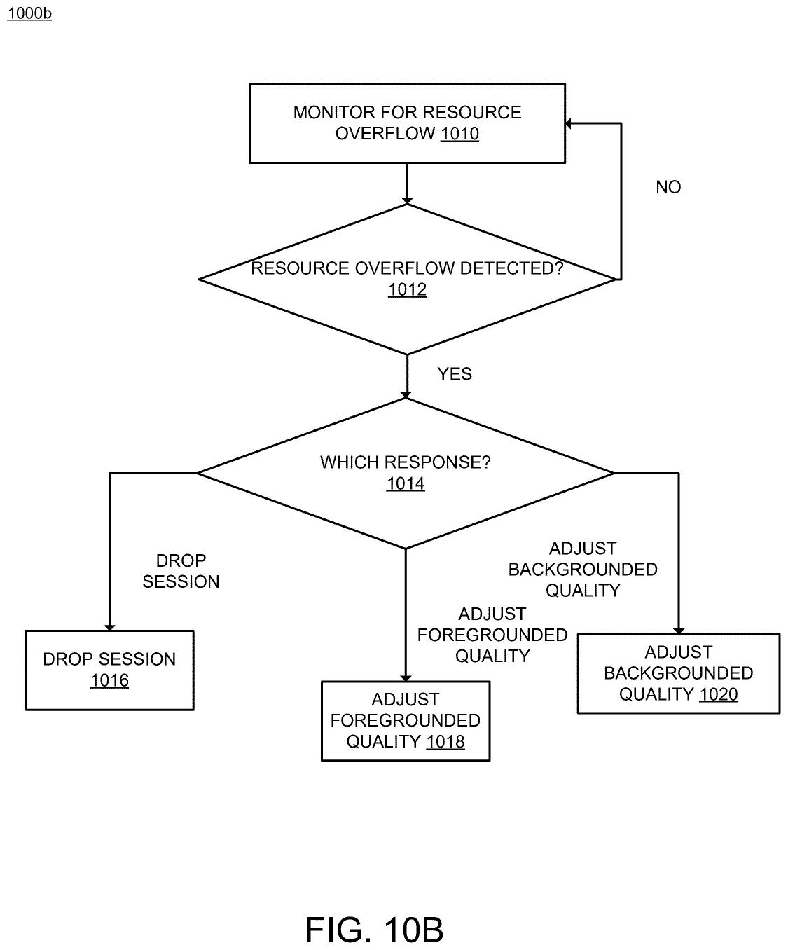

FIG. 10A is a flowchart of a method 1000a for managing and changing between communication sessions in a virtual environment, in accordance with some implementations. Method 1000 may begin at block 1002 or at block 1004.

At block 1002, a text session is provided as the communication session. For example, there may be a window or other user interface that allow users to communicate with one another by sending text messages. As discussed, users may apply effects to the text session (e.g., different fonts, type sizes, formatting, etc.). It is also possible to have two users where one user uses a text session and another user uses a voice session. For example, one user may type in statements and these statements may be sent to the other user, where the statements may become audio by using text-to-speech conversion. Such text-to-speech conversion results may have a variety of aspects (for example, different volumes, rates, pitches, genders, accents). Block 1002 may be followed by block 1006.

At block 1004, a voice session is provided as the communication session. For a voice session a user may use a microphone to record audio, which is then sent to the other users. Any appropriate microphone may be used here, such as a universal serial bus (USB) microphone, an X Connector, locking connector, rubber boot (XLR) microphone, a dynamic microphone, a condenser microphone, a Lavalier microphone, a shotgun microphone, a ribbon microphone, or any other microphone.

As discussed in block 1002, there may be a situation in which one user uses text and the other uses voice. In this case, a user may speak and the speech is recognized using speech recognition technology. The speech recognition permits the speech to be presented as text. Block 1004 may be followed by block 1006.

At block 1006, an immersive session is provided as the communication session. The immersive session may be provided in addition to or instead of the original text session and/or voice session. Block 1006 may be followed by block 1008.

At block 1008, the text and/or voice session is closed. Block 1008 is optional, in that the text and/or voice session may also operate concurrently with the immersive session and/or with one another, as provided in blocks 1002, 1004, and 1006.

FIG. 10B is a flowchart of a method 1000b for managing resource availability in a virtual environment, in accordance with some implementations. Method 1000b may begin at block 1010.

At block 1010, resource overflow is monitored for. For example, the resources and applications of those resources tracked may include memory, network bandwidth, frames-per-second (FPS), battery life, etc. A resource overflow may mean that one or more resources are about to exceed available resources soon or do not have enough remaining resources to last for a set period of time.

For example, an action may lead to an out-of-memory (OOM) error in which available memory is not sufficient to host the communication sessions that are currently active and/or not sufficient to launch new communication session. An action may also use more network bandwidth than is available.

There may also be resource repercussions based on how resources are used. For example, resource usage may affect frames-per-second (FPS). Increasing FPS may increase using resource usage for resources such as processing power, memory resources, and battery usage.

Different resources operate differently. Some resources, such as bandwidth, are available to a certain extent at any given time. For example, if a given communication session uses 200 Mbps of network bandwidth, that amount of network bandwidth is to be available to the communication session on an ongoing basis for the communication session to work properly. By contrast, battery life acts like a stockpile of resources. A battery stores a certain amount of energy and resource overflow corresponds to the battery not lasting long enough to accomplish a certain goal. For example, given a certain set of resource demands, the battery may last five hours. If the user prefers the battery to last for eight hours, the battery status may be considered a situation in which battery consumption is to be modified. Block 1010 may be followed by block 1012.

At block 1012, it is determined if resource overflow is detected. As discussed above, various resources are monitored to determine if ongoing resource usage or new resource usage exceeds available resources or depletes resources too quickly. If so, block 1014 is followed by block 1014. If not, block 1012 is followed by block 1010.

At block 1014, it is determined how to respond to the resource overflow. FIG. 10 illustrates certain examples of how to respond to the resource overflow. Other approaches may also be used in other implementations. If a session is to be dropped, block 1014 is followed by block 1016. If a foregrounded session is to have its quality adjusted, block 1014 is followed by block 1018. If a backgrounded session is to have its quality adjusted, block 1014 is followed by block 1020. It may be noted that the three responsive options provided in block 1016, block 1018, and block 1020 are not to be taken as exclusive and/or limiting. For example, the responses provided in these blocks may be combined, or other actions may be taken to respond to the resource overflow.

At block 1016, a session may be dropped. It may be noted that this approach may be applicable in the context of a situation in which multiple communications are operating concurrently. The session to be dropped may be determined in various ways. One way is to have a user select which session to drop. Other approaches may select a session automatically in various ways.

For example, the session to drop may be selected based on the type of resource overflow (memory, storage, network bandwidth, battery life, etc.) and may try to minimize the number of sessions to drop. Another approach is to associate sessions and/or users with various priorities, and to drop sessions based on the priorities.

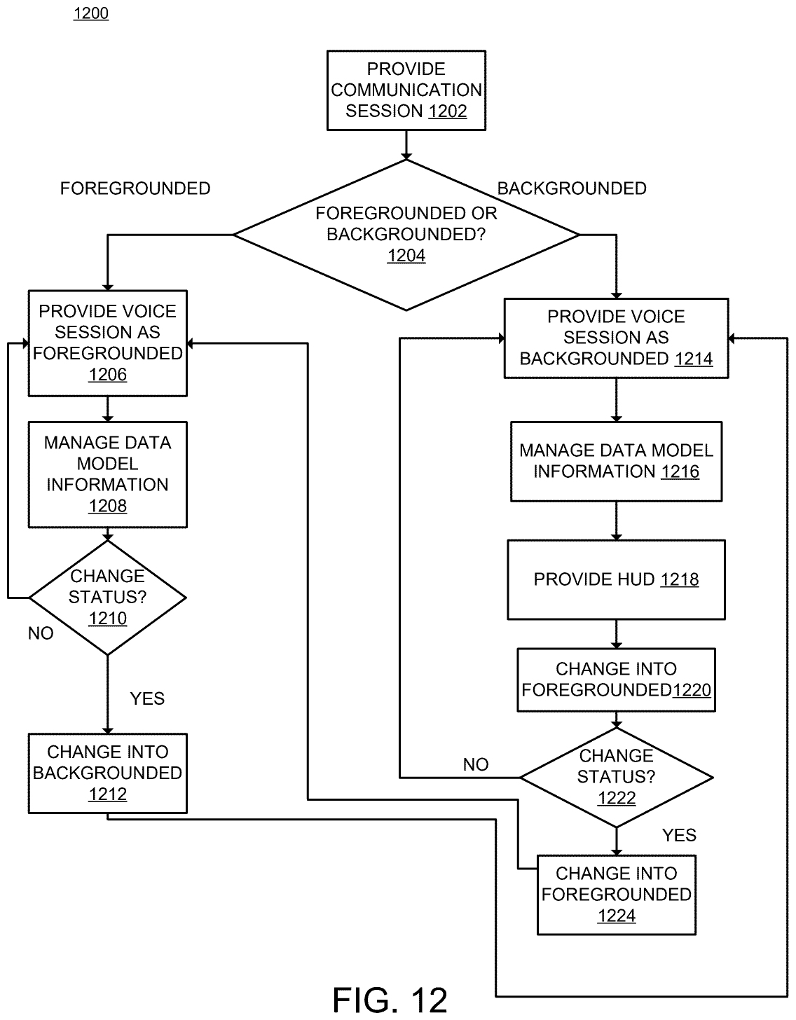

At block 1018, a quality of a foregrounded session may be adjusted to save computational resources. For example, voice quality for the foregrounded may be adjusted to save network bandwidth or extend battery life, such as by changing sample rate or bit depth. A foregrounded session is an active, visible game window that a user is currently interacting with. A backgrounded session occurs when an application is running but is not the active window on a user screen. A foregrounded session tends to take more resources than a backgrounded session, so FIG. 12 illustrates details of ways to allocate additional resources when a session is foregrounded and use fewer resources when a session is backgrounded.

At block 1020, a quality of a backgrounded session may be adjusted to save computational resources. For example, voice quality may be adjusted to save network bandwidth or extend battery life, such as by changing sample rate or bit depth. A backgrounded session tends to take fewer resources than a foregrounded session, so FIG. 12 illustrates details of ways to allocate additional resources when a session is foregrounded and use fewer resources when a session is backgrounded. Backgrounded and foregrounded sessions in this context may refer to whether a communication session is done immersively or not. An immersive (foregrounded) communication implies that there is a virtual environment that requires additional resources to render. Such a session could be switched to backgrounded operation. This approach is similar to how virtual conference software might suggest turning off video when it detects there is network issues.

FIG. 11 is a flowchart of a method 1100 for detecting and responding to non-permissible content, in accordance with some implementations. Method 1100 may begin at block 1102. A particular implementation of the method 1100 is illustrated in FIG. 3, illustrating how to take appropriate action once non-permissible content is detected. FIG. 3 also provides additional discussion of what non-permissible content includes (offensive content, copyrighted content, age-inappropriate content, private content, legally restricted content, etc.) and how the non-permissible content is detected.

At block 1102, non-permissible content is monitored for. The monitoring may occur as discussed in FIG. 3 (rules engine, ML classifier, LLM, etc.). For example, the communication session permits users to communicate, such as by a voice communication session or a text communication session. In some implementations, the communication session may capture the messages in chunks. By using chunks, this may provide some implementations to intercept non-permissible content before another user is exposed to the non-permissible content and adversely affected.

For example, the chunks may be voice or text sent over a certain time window, or another portion of the information shared by the communication session. The chunks may provide an optional delay mechanism, such that it may be possible to intervene with an action before sharing non-permissible content. For example, the chunks may be ten second chunks, thirty second chunks, etc. A ten second chunk Block 1102 may be followed by block 1104.

At block 1104, it is determined if non-permissible content is detected. If not, block 1104 is followed by block 1102 and the monitoring resumes. If so, block 1104 is followed by block 1106 and it is determined how to respond to the non-permissible content.

At block 1106, it is determined which response to take to respond to the detection of the non-permissible content. If the determined response is to warn the violator, block 1106 is followed by block 1108. If the determined response is to warn a non-violating user, block 1106 is followed by block 1110. If the determined response is to take another curative action, block 1106 followed by block 1112.

At block 1108, the violating user is warned. An example of such a warning is presented in FIG. 3. The warning may simply be a warning. In such an example, there are no consequences unless the violating user persists with the non-permissible content). The warning may also be accompanied by a consequence. In some implementations, a warning is the only consequence. In some implementations, once a violating user has been warned, more consequences (which may escalate) are imposed on the violating user, as discussed in block 1112.

At block 1110, the non-violating user is warned. Such a warning may indicate that the non-violating user may take action to protect the non-violating user from the offensive content generated by the violating user. For example, the non-violating user may mute or block the violating user or terminate the communication session. If the non-violating user prefers, in some cases, the non-violating user may override the warning, in case the non-violating user is comfortable with the content. In other implementations, no such override is permissible. For example, if a violating user posts a video clip from a movie rated for adults, and the non-violating user is known to be 12 years old, the video may be blocked regardless.

At block 1112, a curative action may be taken. Such a curative action may automatically impose a penalty on the violating user or automatically take a protective action to protect the non-violating user. For example, as illustrated in FIG. 3, a violating user may be locked out of a communication session for 5 minutes because the violating user used expletives in a voice communication session.

Also, the penalty may increase or otherwise change if a violating user continues with the inappropriate language. For example, if the 5 minute suspension lapses, the violating user may be readmitted to the communication session. If the violating user issues more inappropriate language, the user's account may be fully shut down.

Also, as illustrated in FIG. 3, it may be possible to provide an appeal functionality. For example, if the violating user is penalized for uploading copyrighted content, the violating user may appeal on the basis that the violating user was unaware of the copyright or that the violating user accidentally uploaded the wrong file. Such an appeal may be handled by maintaining a list of acceptable excuses or by human adjudication.

A given user may be allowed to have a certain number of automatically approved appeals, after which a human override is the only way to handle an appeal. For example, the violating user may be given the benefit of the doubt once or twice that the violating user was unaware of a receiving user's age or accidentally uploaded inappropriate content, but the violating user may not use automatically approved excuses indefinitely.

The curative action implemented at block 1112 may involve the non-violating user instead of the violating user. For example, if the violating user shares offensive pictures, portions of the offensive pictures may be blurred when the pictures are viewed by non-violating user. Other implementations may take other curative actions that involve and/or affect the non-violating user. For example, if the violating user gets removed from the platform, the non-violating user might lose a chat history with that user or no longer see the violating user on a friends list.

FIG. 12 is a flowchart of a method 1200 for managing foregrounded and backgrounded communication sessions, in accordance with some implementations. Method 1200 may begin at block 1202.

At block 1202, a communication session is provided. For example, the communication session may be a voice communication session, a text communication session, or an immersive communication session or other type of communication session, and the communication session may be established as illustrated in FIG. 8 and FIG. 9. Block 1202 may be followed by block 1204.

At block 1204, it is determined whether the communication session is a foregrounded communication session or a backgrounded communication session. If the experience for the communication session is backgrounded, there is no visual rendering output of the experience, and no user input (for example, keyboard, mouse, touch, head pose, or hand pose) is sent to the experience. If the experience for the communication session is foregrounded, the experience is presented as a full screen experience. There is at least one experience foregrounded, but such an experience may be a shell for the overall virtual environment. One experience can be foregrounded at a time in some implementations, and the foregrounded experience may be visually rendered to the full virtual environment viewport. In some implementations, all of the users in a communication session experience the communication session as foregrounded. In some implementations, all of the users in a communication session experience the communication session as backgrounded.

It is also possible that some users in a communication session have a foregrounded experience, while others get a backgrounded experience. For example, in video conference software, some users might have their video on and view the conference. Someone who wants to “background” the call might turn off all incoming video as well as their own video and just use audio. The foregrounded experience receives user input by default, unless a window is focused. If the communication session is foregrounded, block 1204 is followed by block 1206. If the communication session is backgrounded, block 1204 is followed by block 1214.

At block 1206, the voice communication session is provided as foregrounded. Aspects of a foregrounded communication session are discussed above. Block 1206 may be followed by block 1208.

At block 1208, the data model information is managed for the voice session. As discussed in FIG. 8, by managing the data model properly, it is possible to coordinate the implementation of the voice session. A data model represents a user's virtual environment session, but on a client. A data model may have a 1:1 mapping to a virtual environment server. Data models are also capable being used to render a visual representation of the virtual experience. If a user wants to be backgrounded, the user can “turn off” the visual rendering for the data model. Block 1208 may be followed by block 1210.

At block 1210, it is determined if there is a change of status (from foregrounded to backgrounded). If not, block 1210 is followed by block 1206 and the voice session continues to operate as a foregrounded voice session. If so (the voice session is backgrounded), block 1210 is followed by block 1212.

In block 1212, the foregrounded voice session is changed into a backgrounded voice session. When this occurs, resources that are used for a foregrounded voice session but not for a backgrounded voice session are released. Visual resources would be an example here. For example, 3D models that are rendered in the immersive communication environment may be cleaned up. Physics related scripts may also be cleaned up, and fonts, textures, and images may be unloaded. Block 1212 may be followed by block 1214, such that the voice communication session is backgrounded.

In block 1214, the voice communication session is provided as backgrounded. Such backgrounded operation is discussed further, above Block 1214 may be followed by block 1216.

At block 1216, the data model information is managed for the voice session. As discussed in FIG. 8, by managing the data model properly, it is possible to coordinate the implementation of the voice session and save resources. If just one user is connected to voice, it may be possible not to initialize the voice logic, but instead it may be possible to wait until another user joins. Block 1216 may be followed by block 1218.

At block 1218, the user is provided with a heads-up-display (HUD). Such a HUD may be a set of controls overlaid over a foregrounded (or windowed experience). Such a HUD may include various controls that allow a user to control various aspects of the voice communication session (for example, volume, muting, audio characteristics, pausing/stopping communication session, etc.).

Block 1218 may be optional, but the HUD may be helpful in that backgrounded experiences do not accept other user input, and hence providing the HUD may be helpful. Some implementations may be configured such that the HUD may be turned on and off. In such implementations, if the HUD is available, the HUD permits a user to have control over the backgrounded experience.

If the HUD is not available, the HUD does not interfere with the foregrounded experience. The HUD may be anchored, such as along an edge of the screen, or the HUD may be floating, such that the user is able to move the HUD around as appropriate to avoid interference with the foregrounded experience. The HUD may also allow users to switch between backgrounded and foregrounded operation. For example, the HUD may allow a user to jump into the immersive connection experience and background the current foregrounded experience. Block 1218 may be followed by block 1220.

At block 1220, it is determined if there is a change in status. If not, block 1220 is followed by block 1214 and the voice session continues as being provided as a backgrounded experience. If so, block 1220 is followed by block 1222.

At block 1222, the status of operation for a given virtual experience changes from backgrounded into foregrounded. When this occurs, resources that are used for a foregrounded voice session but not for a backgrounded voice session are generated and updated appropriately.

While FIG. 12 illustrates communication sessions as being foregrounded or backgrounded, sometimes communications sessions are associated with windows. Such windows have some of the properties of foregrounded experiences, and some of the properties of backgrounded experiences. Some implementations could provide a picture-in-picture experience, such that there may be two experiences running at the same time. One experience may be the main experience, to which input controls point. This experience may take up most of the screen. The other experience may be in a floating window where a user can see what is happening. However, to interact with the other experience, the user must switch it to full screen operation.

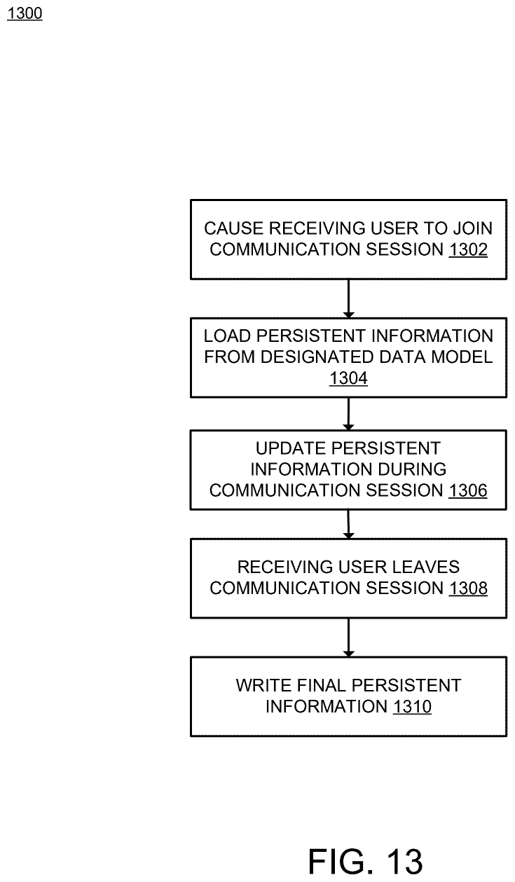

FIG. 13 a flowchart of a method 1300 for managing persistent information as users join and leave communication sessions, in accordance with some implementations. Method 1300 may begin at block 1302.

At block 1302, a receiving user is caused to join a communication session, which may be associated with one or more virtual experiences as discussed herein. Block 1302 is similar to corresponding blocks of FIG. 9 in which a receiving user is requested to join a communication session and then does so. When the receiving user joins the communication session, that communication session (and any associated virtual experience) may access persistent information for the receiving user. Block 1302 may be followed by block 1304.

At block 1304, persistent information is loaded from a designated data model. The designated data model is the designated data model associated with the communication session and/or virtual experience. Such persistent information refers to information about the receiving user that is to be managed such that by operating multiple instances, the persistent information does not become incorrect, such as an amount of currency, or an inventory item.

For example, if a user has an avatar with a quiver of twelve arrows, persistent information may include ensuring that the arrow count is tracked accurately. The persistent information may be loaded from a central source for the virtual environment. As the persistent information changes in multiple experiences, it may be relevant to track how the persistent information changes. Block 1304 may be followed by block 1306.

At block 1306, persistent information changes are automatically propagated/updated. For example, every time persistent information changes, the changes could be propagated (for example, every time a user fires an arrow). This approach could be resource intensive, and the propagation could occur at certain time intervals or once a certain amount of change has occurred. Such propagation can ensure that a user does not spend more money than the user has available or get an error from running out of arrows in a quiver when the user already acquired more arrows. Block 1306 may be followed by block 1308.

At block 1308, the receiving user leaves the communication session. When this departure occurs, any changes to the persistent information are finished with being changed. Hence, the changes are to be recorded. Further, once the user has left at block 1308, block 1308 can lock the persistent information, set a flag, or the like, indicating that the virtual experience being closed no longer affects the persistent information. If the virtual experience is reopened, this setting may change. Block 1308 may be followed by block 1310.

At block 1310, the persistent information is written to the designated data model. Any remaining changes from the designated data model that occurred in a virtual experience are updated to reflect any changes that were made during the communication session. For example, if a user fired four arrows in a given experience since the last update, that is to be reflected. Data models exist on the client, and persistence means that the client connects to a server instance. That server instance may persist information through methods like a database, or in a memory cache. Persistence means that the data model is doing some sort of synchronization. Otherwise, if the user reinstalls the app or signs onto a different device, the user loses that persisted data.

After block 1310, the designated data model is not changed further unless there is a new communication session that would require further changes and synchronization.

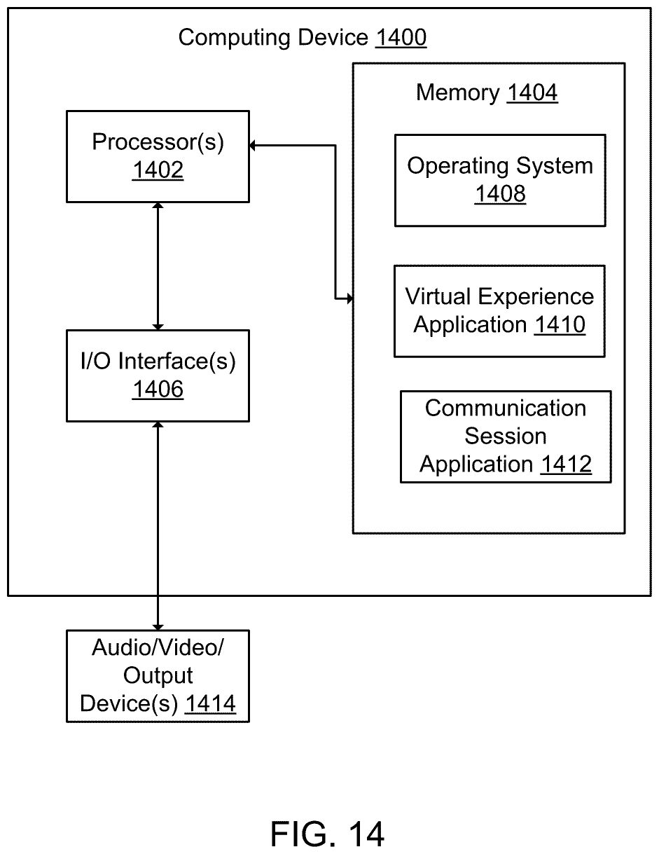

FIG. 14 is a block diagram that illustrates an example computing device 1400 which may be used to implement one or more features described herein, in accordance with some implementations. In one example, computing device 1400 may be used to implement a computer device (e.g., server 102 and/or client device 110 of FIG. 1), and perform appropriate method implementations described herein. Computing device 1400 can be any suitable computer system, server, or other electronic or hardware device. For example, the computing device 1400 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1400 includes a processor 1402, a memory 1404, input/output (I/O) interfaces 1406, and audio/video input/output devices 1414.

Processor 1402 can be one or more processors and/or processing circuits to execute program code and control basic operations of the computing device 1400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1404 is typically provided in computing device 1400 for access by the processor 1402, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1402 and/or integrated therewith. Memory 1404 can store software operating on the computing device 1400 by the processor 1402, including an operating system 1408, a virtual experience application 1410, a communication session application 1412, and other applications (not shown). In some implementations, virtual experience application 1410 and/or communication session application 1412 can include instructions that enable processor 1402 to perform the functions (or control performance of the functions of) described herein (e.g., some or all of the methods described with respect to FIGS. 9, 10A-10B, and 11-13).

For example, virtual experience application 1410 (which can be embodied by the virtual experience applications 112 or 132 in FIG. 1) can include a communication session application 1412, which as described herein can manage communication sessions within an online virtual experience server (e.g., server 102). Elements of software in memory 1404 can alternatively be stored on any other suitable storage location or computer-readable medium. In addition, memory 1404 (and/or other connected storage device(s)) can store instructions and data used in the features described herein. Memory 1404 and any other type of storage (magnetic disk, optical disk, magnetic tape, or other tangible media) can be considered “storage” or “storage devices.”

I/O interface(s) 1406 (which can be embodied by the I/O interface 114 of FIG. 1) can provide functions to enable interfacing the computing device 1400 with other systems and devices. For example, network communication devices, storage devices (e.g., memory and/or data store 120), and input/output devices can communicate via I/O interface(s) 1406. In some implementations, the I/O interface(s) 1406 can connect to interface devices including input devices (e.g., keyboard, pointing device, touchscreen, microphone, camera, scanner, etc.) and/or output devices (e.g., display device, speaker devices, printer, motor, etc.).

The audio/video input/output devices 1414 can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 14 shows one block for each of processor 1402, memory 1404, I/O interface(s) 1406, and software blocks of operating system 1408, virtual experience application 1410, and communication session application 1412. These blocks may represent one or more processors or processing circuitries, operating systems, memories, I/O interfaces, applications, and/or software engines. In other implementations, computing device 1400 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform or control performance of the operations described.

A user device can also implement and/or be used with features described herein. Example user devices can be computer devices including some similar components as the computing device 1400 (e.g., processor(s) 1402, memory 1404, and I/O interface(s) 1406). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 1414, for example, can be connected to (or included in) the computing device 1400 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

One or more methods described herein (e.g., methods 900, 1000a, 1000b, 1100, 1200, and 1300) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to provide cross-experience communication in a virtual environment that hosts a plurality of virtual experiences, the method comprising:
receiving a request from a requesting user in a first virtual experience of the virtual environment to form a communication session with a receiving user in a second virtual experience of the virtual environment;
verifying a permission for the requesting user to form the communication session;
in response to successfully verifying the permission:
reserving a platform instance in the virtual environment to coordinate forming the communication session;
notifying the receiving user about the communication session;
receiving a notification from the receiving user accepting the communication session;
notifying the requesting user that the communication session was accepted;
starting a designated data model associated with the requesting user to host the communication session; and
forming the communication session between the requesting user and the receiving user using the designated data model and the platform instance, the designated data model having access to a subset of information in a data model associated with the receiving user, wherein the subset of information is related to the communication session.

2. The computer-implemented method of claim 1, wherein the communication session includes a private text communication session, a private voice communication session, a private immersive communication session hosted in the virtual environment, or a combination thereof.

3. The computer-implemented method of claim 2, further comprising transitioning from the private text communication session or the private voice communication session to the private immersive communication session, wherein the private immersive communication session is hosted as an additional virtual experience in the virtual environment.

4. The computer-implemented method of claim 1, further comprising:
monitoring the communication session in real time or near real time to detect if non-permissible content is provided by a particular user in the communication session;
in response to detecting non-permissible content, performing at least one of:
providing a warning to the particular user;
providing a warning to another user; or
taking a curative action, wherein the curative action comprises at least one of blocking the particular user from providing further content in the communication session, modifying the non-permissible content before the non-permissible content is provided to other users in the communication session, removing the particular user from the communication session, or blocking access of the particular user to the virtual environment.

5. The computer-implemented method of claim 1, wherein the communication session is a voice communication session that is presented to a given user as a foregrounded voice communication session or a backgrounded voice communication session.

6. The computer-implemented method of claim 5, wherein the designated data model does not replicate information related to foregrounded operation when the communication session is the backgrounded voice communication session, and the designated data model is updated to include the information related to the foregrounded operation if the foregrounded voice communication session takes on operation.

7. The computer-implemented method of claim 5, further comprising providing a voice heads-up-display (HUD) to the given user for controlling the communication session when the communication session is the backgrounded voice communication session.

8. The computer-implemented method of claim 1, further comprising detecting that providing one or more communication sessions exceeds available computing resource capacity, and responding by dropping a communication session, adjusting a quality of a foregrounded communication session virtual experience such that the adjusting results in reduction in a usage of computing resources, adjusting a quality of a backgrounded communication session experience such that the adjusting results in reduction in the usage, or a combination thereof.

9. The computer-implemented method of claim 1, wherein information stored in the designated data model is removed on-demand in response to a corresponding communication session being backgrounded.

10. The computer-implemented method of claim 1, wherein audio for a communication session may be muted and unmuted independently from environment audio from the first virtual experience or the second virtual experience.

11. The computer-implemented method of claim 1, wherein persistent information for the designated data model is loaded when the receiving user joins the communication session, and updated persistent information is written to the designated data model when the receiving user leaves the communication session.

12. The computer-implemented method of claim 1, further comprising receiving a request from the requesting user to receive a list of eligible receiving users, wherein the requesting user selects the receiving user from the list.

13. A non-transitory computer-readable medium with instructions stored thereon that, responsive to execution by a processing device, causes the processing device to perform or control performance of operations to provide cross-experience communication in a virtual environment that hosts a plurality of virtual experiences, the operations comprising:
receiving a request from a requesting user in a first virtual experience of the virtual environment to form a communication session with a receiving user in a second virtual experience of the virtual environment;
verifying a permission for the requesting user to form the communication session;
in response to successfully verifying the permission:
reserving a platform instance in the virtual environment to coordinate forming the communication session;
notifying the receiving user about the communication session;
receiving a notification from the receiving user accepting the communication session;
notifying the requesting user that the communication session was accepted;
starting a designated data model associated with the requesting user to host the communication session; and
forming the communication session between the requesting user and the receiving user using the designated data model and the platform instance, the designated data model having access to a subset of information in a data model associated with the receiving user, wherein the subset of information is related to the communication session.

14. The non-transitory computer-readable medium of claim 13, wherein the communication session includes a private text communication session, a private voice communication session, a private immersive communication session hosted in the virtual environment, or a combination thereof.

15. The non-transitory computer-readable medium of claim 13, wherein the operations further comprise detecting that providing one or more communication sessions exceeds available computing resource capacity, and responding by dropping a communication session, adjusting a quality of a foregrounded communication session experience such that the adjusting results in reduction in a usage of computing resources, adjusting a quality of a backgrounded communication session experience such that the adjusting results in reduction in the usage, or a combination thereof.

16. The non-transitory computer-readable medium of claim 13, wherein information stored in the designated data model is removed on-demand in response to a corresponding communication session being backgrounded.

17. A system comprising:
a memory with instructions stored thereon; and
a processing device, coupled to the memory, the processing device configured to access the memory and execute the instructions, wherein the instructions cause the processing device to perform or control performance of operations to provide cross-experience communication in a virtual environment that hosts a plurality of virtual experiences, the operations comprising:
receiving a request from a requesting user in a first virtual experience of the virtual environment to form a communication session with a receiving user in a second virtual experience of the virtual environment;
verifying a permission for the requesting user to form the communication session;
in response to successfully verifying the permission:
reserving a platform instance in the virtual environment to coordinate forming the communication session;
notifying the receiving user about the communication session;
receiving a notification from the receiving user accepting the communication session;
notifying the requesting user that the communication session was accepted;
starting a designated data model associated with the requesting user to host the communication session; and
forming the communication session between the requesting user and the receiving user using the designated data model and the platform instance, the designated data model having access to a subset of information in a data model associated with the receiving user, wherein the subset of information is related to the communication session.

18. The system of claim 17, wherein the communication session includes a private text communication session, a private voice communication session, a private immersive communication session hosted in the virtual environment, or a combination thereof.

19. The system of claim 17, wherein the operations further comprise detecting that providing one or more communication sessions exceeds available computing resource capacity, and responding by dropping a communication session, adjusting a quality of a foregrounded communication session experience such that the adjusting results in reduction in a usage of computing resources, adjusting a quality of a backgrounded communication session experience such that the adjusting results in reduction in the usage, or a combination thereof.

20. The system of claim 17, wherein information stored in the designated data model is removed on-demand in response to a corresponding communication session being backgrounded.
